(19) United States
(12) Patent Application Publication
(10) Pub. No.: US 2025/0343916 A1
(43) Pub. Date: Nov. 6, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 19/267,443

(22) Filed: Jul. 11, 2025

Related U.S. Application Data
(63) Continuation of application No. PCT/CN2024/071890, filed on Jan. 11, 2024.

(30) Foreign Application Priority Data
Jan. 13, 2023 (WO) PCT/CN2023/072006

(51) Int. Cl. H04N 19/136; H04N 19/159; H04N 19/176

(52) U.S. Cl. CPC H04N 19/136; H04N 19/159; H04N 19/176

(57) ABSTRACT

Embodiments of the present disclosure provide a solution for video processing. A method for video processing is proposed. In the method, for a conversion between a current video block of a video and a bitstream of the video, a filtered prediction of the current video block is determined based on an offset based regression model. The offset based regression model modulates a relationship between a current area and a reference area of the current video block. The conversion is performed based on the filtered prediction.

### CROSS REFERENCE TO RELATED APPLICATIONS

This application is a continuation of International Application No. PCT/CN2024/071890, filed on Jan. 11, 2024, which claims the benefit of International Application No. PCT/CN2023/072006 filed on Jan. 13, 2023. The entire contents of these applications are hereby incorporated by reference in their entireties.

### FIELDS

Embodiments of the present disclosure relates generally to video processing techniques, and more particularly, to regression model for prediction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a filtered prediction of the current video block based on an offset based regression model, the offset based regression model modulating a relationship between a current area and a reference area of the current video block; and performing the conversion based on the filtered prediction. The method in accordance with the first aspect of the present disclosure determines a filtered prediction by using an offset based regression model. The coding efficiency and coding effectiveness can thus be improved.

In a second aspect, another method for video processing is proposed. The method comprises: determining, for a conversion between a current video block of a video and a bitstream of the video, a prediction of the current video block based on a local illumination compensation (LIC), the LIC being based on a regression model modulating a relationship between a current area and a reference area of the current video block for the LIC; and performing the conversion based on the prediction. The method in accordance with the second aspect of the present disclosure applies the LIC based on a regression model. The coding efficiency and coding effectiveness can thus be improved.

In a third aspect, another method for video processing is proposed. The method comprises: applying, for a conversion between a current video block of a video and a bitstream of the video, at least one intra fusion for at least one color component to the current video block based on more than two reference lines; and performing the conversion based on the applying. The method in accordance with the third aspect of the present disclosure applies the intra fusion for a color component based on a plurality of reference lines. The coding efficiency and coding effectiveness can thus be improved.

In a fourth aspect, an apparatus for video processing is proposed. The apparatus comprises a processor and a non-transitory memory with instructions thereon. The instructions upon execution by the processor, cause the processor to perform a method in accordance with the first aspect, the second aspect or the third aspect of the present disclosure.

In a fifth aspect, a non-transitory computer-readable storage medium is proposed. The non-transitory computer-readable storage medium stores instructions that cause a processor to perform a method in accordance with the first aspect, the second aspect or the third aspect of the present disclosure.

In a sixth aspect, a non-transitory computer-readable recording medium is proposed. The non-transitory computer-readable recording medium stores a bitstream of a video which is generated by a method performed by an apparatus for video processing. The method comprises: determining a filtered prediction of a current video block of the video based on an offset based regression model, the offset based regression model modulating a relationship between a current area and a reference area of the current video block; and generating the bitstream based on the filtered prediction.

In a seventh aspect, a method for storing a bitstream of a video is proposed. The method comprises: determining a filtered prediction of a current video block of the video based on an offset based regression model, the offset based regression model modulating a relationship between a current area and a reference area of the current video block; generating the bitstream based on the filtered prediction; and storing the bitstream in a non-transitory computer-readable recording medium.

In an eighth aspect, another non-transitory computer-readable recording medium is proposed. The non-transitory computer-readable recording medium stores a bitstream of a video which is generated by a method performed by an apparatus for video processing. The method comprises: determining a prediction of a current video block of the video based on a local illumination compensation (LIC), the LIC being based on a regression model modulating a relationship between a current area and a reference area of the current video block for the LIC; and generating the bitstream based on the prediction.

In a ninth aspect, another method for storing a bitstream of a video is proposed. The method comprises: determining a prediction of a current video block of the video based on a local illumination compensation (LIC), the LIC being based on a regression model modulating a relationship between a current area and a reference area of the current video block for the LIC; generating the bitstream based on the prediction; and storing the bitstream in a non-transitory computer-readable recording medium.

In a tenth aspect, another non-transitory computer-readable recording medium is proposed. The non-transitory computer-readable recording medium stores a bitstream of a video which is generated by a method performed by an apparatus for video processing. The method comprises: applying at least one intra fusion for at least one color component to a current video block of the video based on more than two reference lines; and generating the bitstream based on the applying.

In an eleventh aspect, another method for storing a bitstream of a video is proposed. The method comprises: applying at least one intra fusion for at least one color component to a current video block of the video based on more than two reference lines; generating the bitstream based on the applying; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4A and FIG. 4B illustrate the effect of the slope adjustment parameter “u”, where FIG. 4A corresponds to a model created with the current CCLM, and FIG. 4B corresponds to a model updated as proposed;

FIG. 5 illustrates neighbouring blocks (L, A, BL, AR, AL) used in the derivation of a general MPM list;

FIG. 6 illustrates neighboring reconstructed samples used for DIMD chroma mode;

FIG. 7 illustrates an intra template matching search area used;

FIG. 8A and FIG. 8B illustrate a division method for angular modes, respectively;

FIG. 9 illustrates an extended MRL candidate list;

FIG. 10 illustrates a spatial part of the convolutional filter;

FIG. 11 illustrates a reference area (with its paddings) used to derive the filter coefficients;

FIG. 12 illustrates four Sobel based gradient patterns for GLM;

FIG. 13 illustrates a template area;

FIG. 14 illustrates positions of spatial merge candidates;

FIG. 15 illustrates candidate pairs considered for redundancy check of spatial merge candidates;

FIG. 16 illustrates motion vector scaling for temporal merge candidate;

FIG. 17 illustrates Candidate positions for temporal merge candidate, C₀ and C₁;

FIG. 18 illustrates MMVD search point;

FIG. 19 illustrates extended CU region used in BDOF;

FIG. 20 illustrates an illustration for symmetrical MVD mode;

FIG. 21 illustrates a decoding side motion vector refinement;

FIG. 22 illustrates top and left neighboring blocks used in CIIP weight derivation;

FIG. 23 illustrates examples of the GPM splits grouped by identical angles;

FIG. 24 illustrates a uni-prediction MV selection for geometric partitioning mode;

FIG. 25 illustrates exemplified generation of a blending weight w₀ using geometric partitioning mode;

FIG. 26 illustrates a flowchart of a method for video processing in accordance with embodiments of the present disclosure;

FIG. 27 illustrates a flowchart of a method for video processing in accordance with embodiments of the present disclosure;

FIG. 28 illustrates a flowchart of a method for video processing in accordance with embodiments of the present disclosure; and

FIG. 29 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

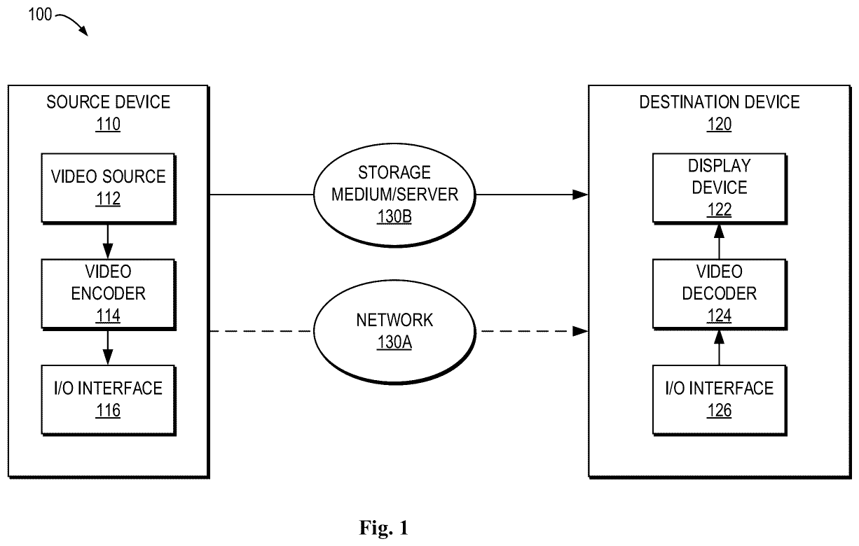

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

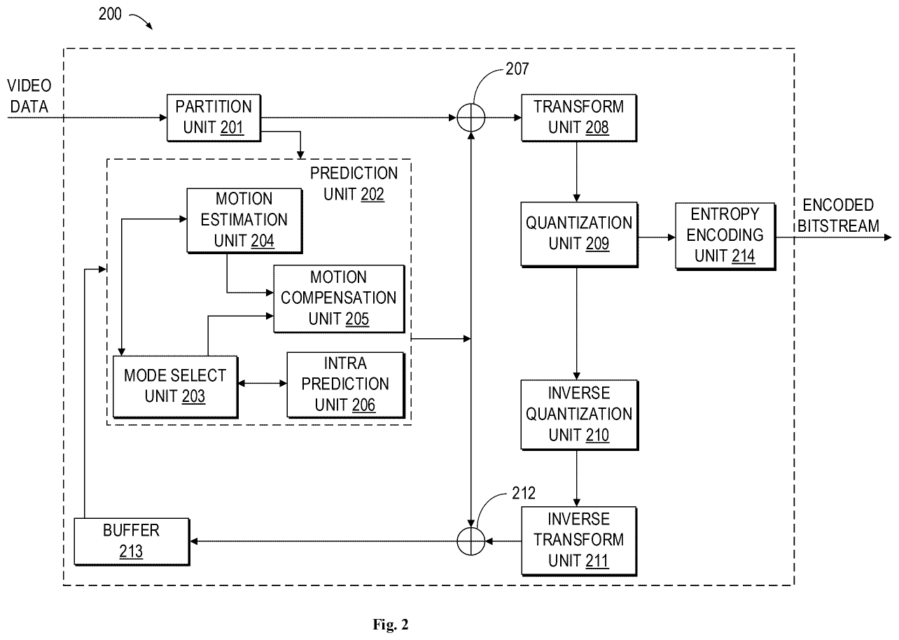

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

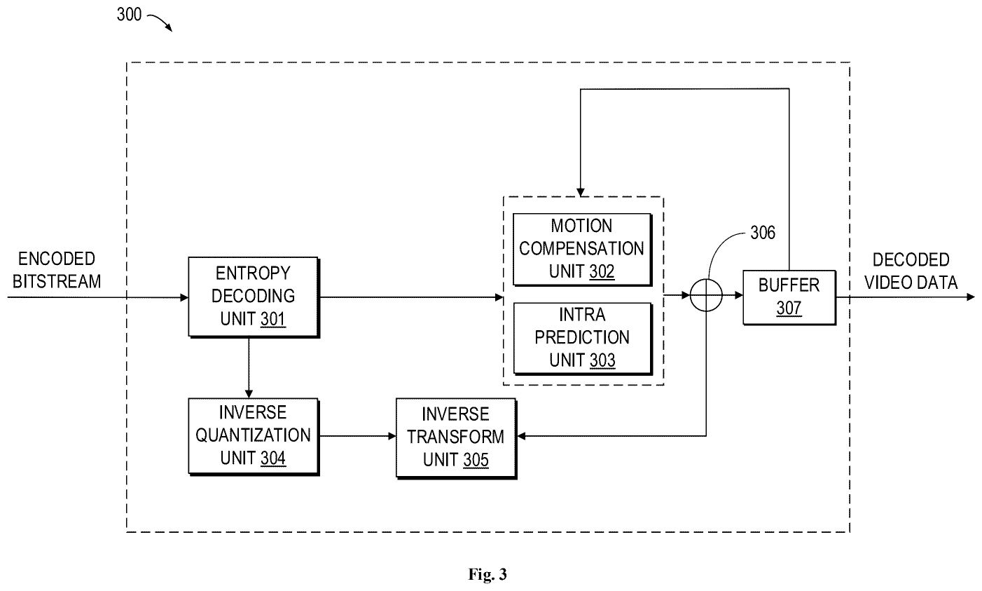

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.
1. Brief Summary

This disclosure is related to video coding technologies. Specifically, it is about linear/non-linear/polynomial regression model prediction, and offset removal related algorithms in image/video coding. It may be applied to the existing video coding standard like HEVC, VVC, and etc. It may be also applicable to future video coding standards or video codec.
2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.
2.1 Intra prediction

In intra prediction the smallest chroma intra prediction unit (SCIPU) constraint in VVC is removed. In addition, the VPDU constraint for reducing CCLM prediction latency is also removed.
2.1.1 Multi-model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.
2.1.1.1 Slope adjustment of CCLM

CCLM uses a model with 2 parameters to map luma values to chroma values. The slope parameter “a” and the bias parameter “b” define the mapping as follows:

$$chromaVal = a * lumaVal + b .$$

An adjustment “u” to the slope parameter is signaled to update the model to the following form:

$$chromaVal = {a}^{′} * lumaVal + {b}^{′}$$

$$where$$

$${a}^{′} = a + u ,$$

$${b}^{′} = b - u * {y}_{r} .$$

With this selection the mapping function is tilted or rotated around the point with luminance value yr. The average of the reference luma samples used in the model creation as yr in order to provide a meaningful modification to the model. Picture below illustrates the process.

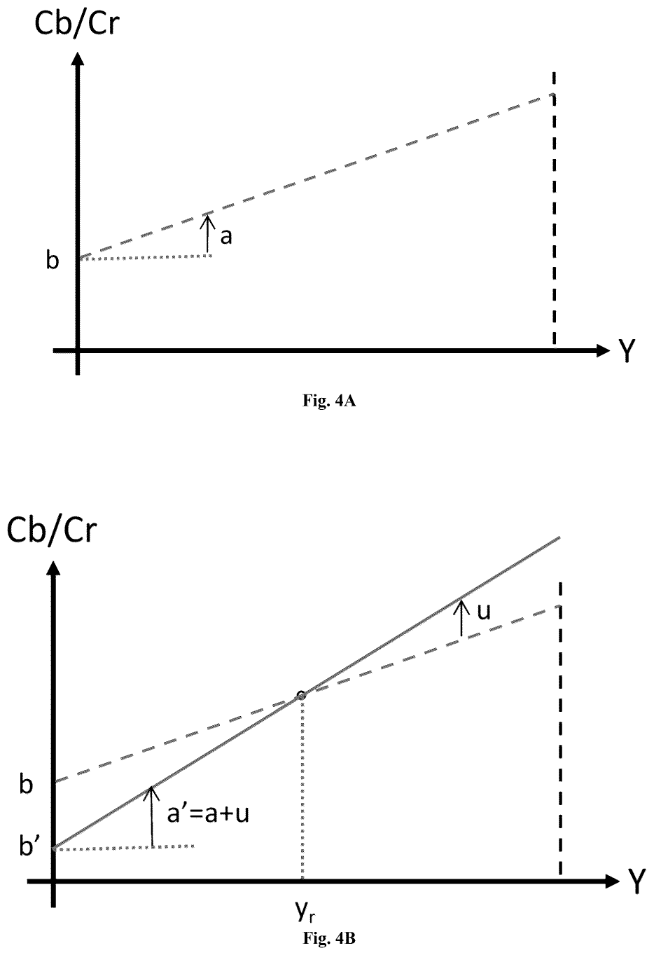

FIG. 4A and FIG. 4B illustrate the effect of the slope adjustment parameter “u”, where FIG. 4A corresponds to a model created with the current CCLM, and FIG. 4B corresponds to a model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.
2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.
2.1.3 Secondary MPM

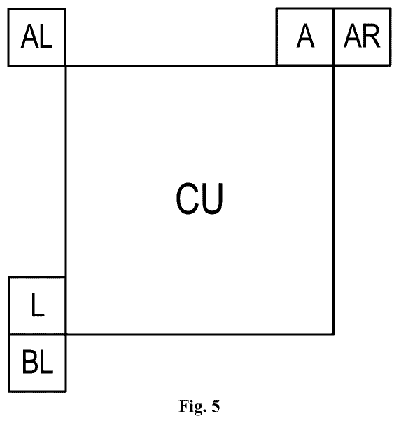

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 5, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

FIG. 5 illustrates neighbouring blocks (L, A, BL, AR, AL) used in the derivation of a general MPM list.

A PMPM flag is parsed first, if equal to 1 then a PMPM index is parsed to determine which entry of the PMPM list is selected, otherwise the SPMPM flag is parsed to determine whether to parse the SMPM index or the remaining modes.
2.1.4 Reference sample interpolation and smoothing for intra-prediction

The 4-tap cubic interpolation is replaced with a 6-tap cubic interpolation filter, for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.
2.1.5 Decoder side intra mode derivation (DIMD)

When DIMD is applied, two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( G x ) )$$

$$normDiff = ( ( Gx ≪ 4 ) ≫ x ) \& 15$$

$$x += ( 3 + ( normDiff != 0 ) ? 1 : 0 )$$

$$Orient = ( Gy * ( DivSigTable [ normDiff ] \vert 8 ) + ( 1 ≪ ( x - 1 ) ) ) ≫ x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.
2.1.5.1 DIMD chroma mode

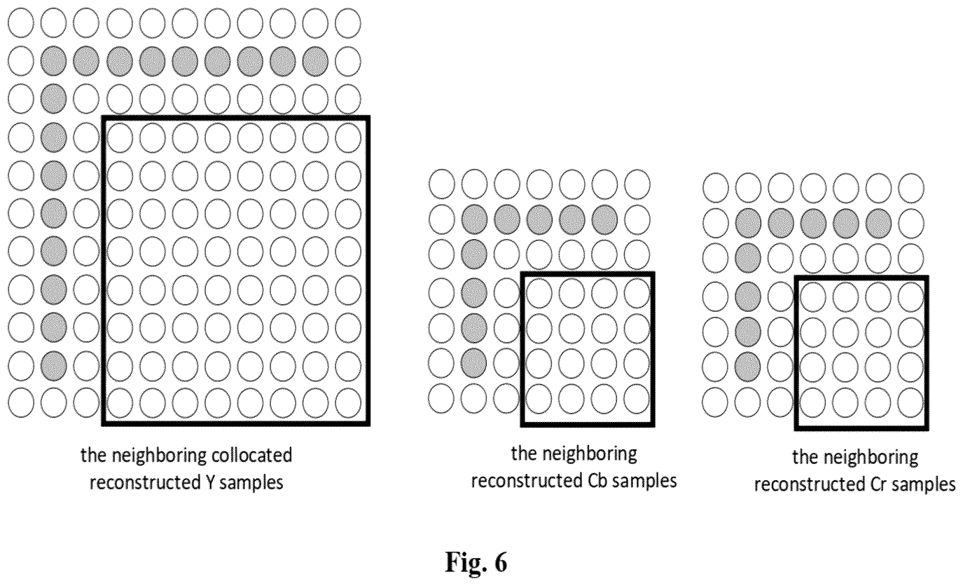

The DIMD chroma mode uses the DIMD derivation method to derive the chroma intra prediction mode of the current block based on the neighboring reconstructed Y, Cb and Cr samples in the second neighboring row and column as shown in FIG. 6. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

FIG. 6 illustrates neighboring reconstructed samples used for DIMD chroma mode.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.
2.1.6 Fusion of chroma intra prediction modes

The DM mode and the four default modes can be fused with the MMLM_LT mode as follows:

$$pred = ( w 0 * pred 0 + w 1 * pred 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signaled to indicate whether the fusion is applied. This method only applies to I slices.
2.1.7 Intra template matching

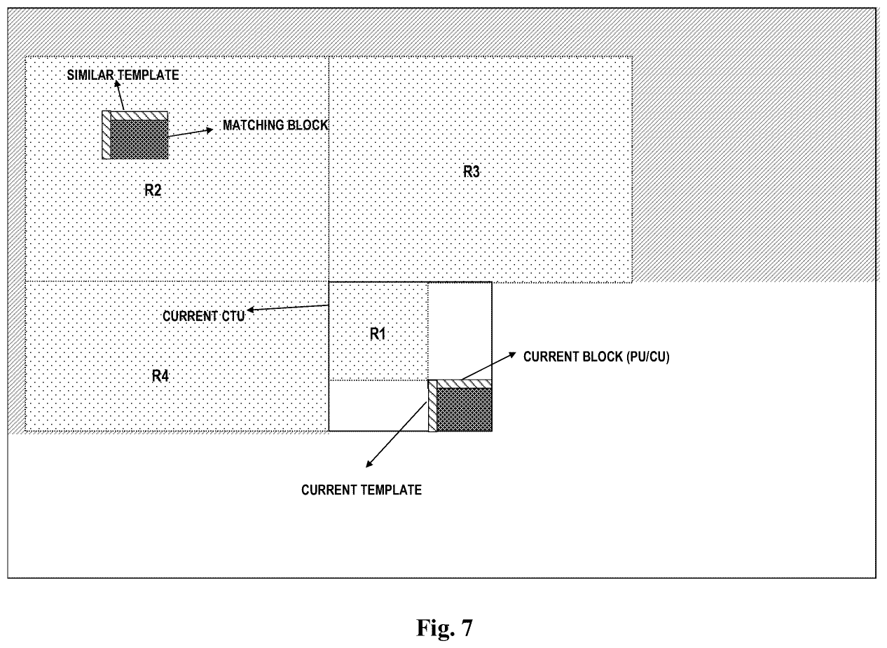

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. The prediction signal is generated by matching the L-shaped causal neighbor of the current block with another block in a predefined search area in FIG. 7 consisting of:
R1: current CTU,
R2: top-left CTU,
R3: above CTU,
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW ,$$

$$SearchRange\_h = a * BlkH .$$

Where ‘a’ is a constant that controls the gain/complexity trade-off. In practice, ‘a’ is equal to 5.

FIG. 7 illustrates an intra template matching search area used.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.
2.1.8 Fusion for template-based intra mode derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$weight 1 = costMode 2 / ( costMode 1 + costMode 2 ) ,$$

$$weight 2 = 1 - weight 1.$$

The division operations are conducted using the same lookup table (LUT) based integerization scheme used by the CCLM.
2.1.9 Combination of CIIP with TIMD and TM merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

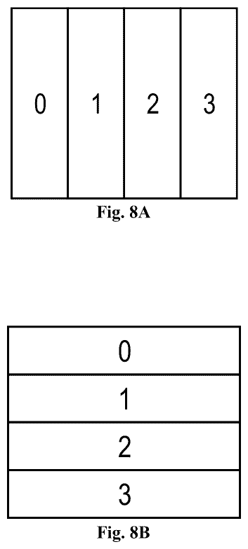

FIG. 8A and FIG. 8B illustrate a division method for angular modes, respectively.

In addition, it is also proposed to modify the weights (wIntra, wInter) for the two tests if the derived intra prediction mode is an angular mode. For near-horizontal modes (2<=angular mode index <34), the current block is vertically divided as shown in FIG. 8A; for near-vertical modes (34<=angular mode index <=66), the current block is horizontally divided as shown in FIG. 8B.

The (wIntra, wInter) for different sub-blocks are shown in Table 1.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.
2.1.10 Extended multiple reference line (MRL) list

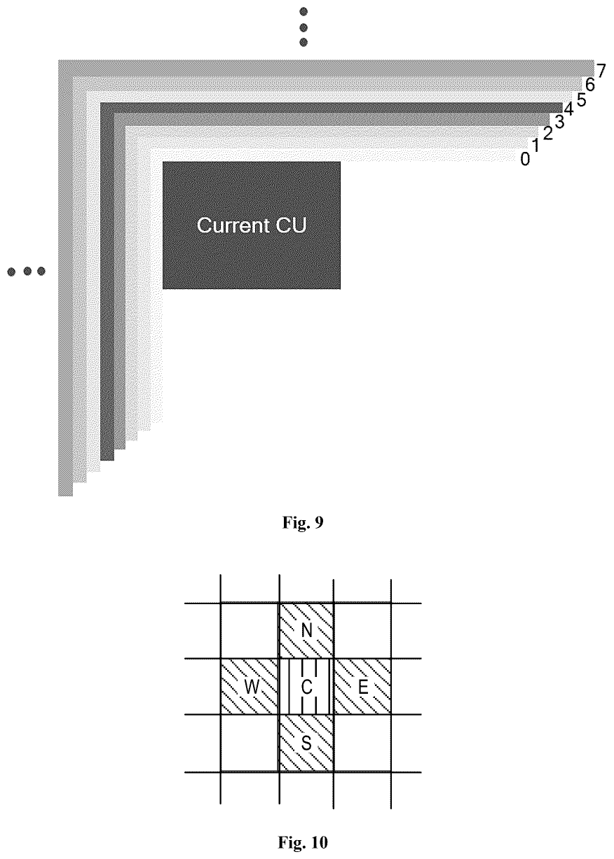

MRL list in VVC is extended to include more reference lines for intra prediction. The extended reference line list consists of line indices {1, 3, 5, 7, 12} as shown FIG. 9. FIG. 9 illustrates an extended MRL candidate list. For template-based intra mode derivation (TIMD), instead of the full MRL candidate list, only the first two reference line candidates, i.e., {1, 3}, are used.
2.1.11 Convolutional cross-component intra prediction model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.
2.1.11.1 Convolutional filter

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated below.

FIG. 10 illustrates a spatial part of the convolutional filter.

The nonlinear term P is represented as power of two of the center luma sample C and scaled to the sample value range of the content:

$$P = ( C * C + midVal ) ≫ bitDepth .$$

That is, for 10-bit content it is calculated as:

$$P = ( C * C + 5 \; 12 ) ≫ 10.$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

2.1.11.2 Calculation of filter coefficients

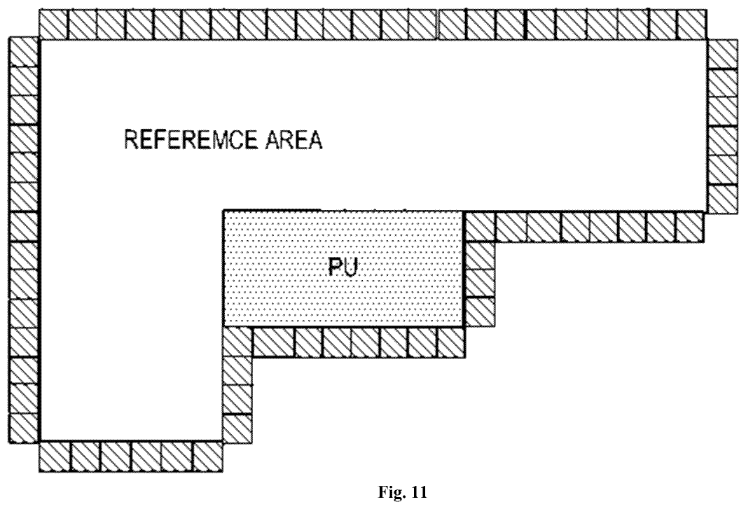

The filter coefficients ci are calculated by minimising MSE between predicted and reconstructed chroma samples in the reference area. FIG. 11 illustrates the reference area which consists of 6 lines of chroma samples above and left of the PU. FIG. 11 illustrates the reference area (with its paddings) used to derive the filter coefficients. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.
2.1.11.3 Gradient linear model

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

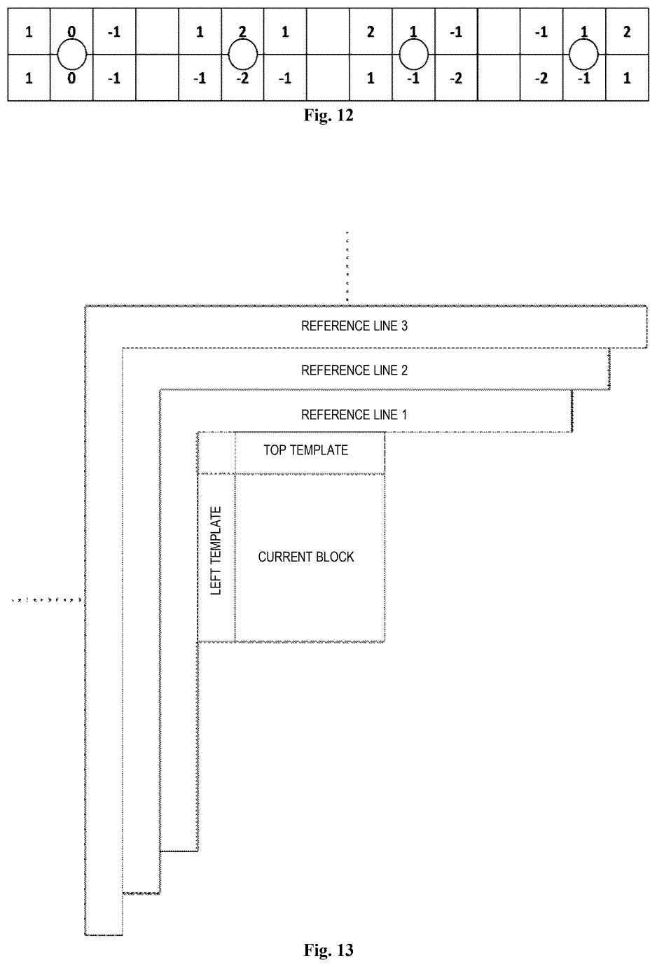

For signaling, when the CCLM mode is enabled to the current CU, two flags are signaled separately for Cb and Cr components to indicate whether GLM is enabled to each component; if the GLM is enabled for one component, one syntax element is further signaled to select one of 4 gradient filters for the gradient calculation.
Four gradient filters are enabled for the GLM, as illustrated in FIG. 12, which illustrates four Sobel based gradient patterns for GLM.
2.1.11.4 Gradient linear model with luma value

In ECM-6.0, GLM utilizes the gradient of luma samples to predict a chroma sample as:

$$p r e {d}_{C} ( i , j ) = α \cdot G ( i , j ) + β ,$$

where pred_{C}(i,j) represents the predicted value of a chroma sample, G(i, j) represents the gradient of the corresponding reconstructed luma samples, and the linear model parameters α and β are derived by adjacent reconstructed samples based on the linear minimum mean square error (LMMSE) method as CCLM.

In the tests, a new GLM mode is evaluated that a chroma sample is predicted based on both the gradient G(i,j) of luma samples and the reconstructed value rec_{L}′(i, j) of the down-sampled luma sample with different parameters:

$$p r e {d}_{C} ( i , j ) = {α}_{0} \cdot G ( i , j ) + {α}_{1} \cdot {rec}_{L}^{′} ( i , j ) + {α}_{2} \cdot midValue ,$$

where the model parameters α₀, α₁ and α₂ are derived from 6 rows and columns adjacent samples based on the LDL decomposition method as the CCCM mode in ECM-6.0.

For signalling, one flag is signaled to indicate whether GLM is enabled to both Cb and Cr components, and the syntax element that indicates the gradient pattern is coded by truncated unary code.

The original GLM mode is reserved and the new GLM mode is signalled as an additional mode by signaling one extra flag in the bitstream.
2.1.11.5 Bitstream signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.
2.1.12 Template-based multiple reference line intra prediction

In template-based multiple reference line intra prediction, instead of signalling the reference line and the intra mode directly, an index to the candidate list is coded to indicate which combination of the reference line and prediction mode is used for coding the current block, a truncated Golomb-Rice coding with a divisor 4 is employed to code selected combinations from the combination list.

The list of 20 candidates is constructed by combining an MPM with the reference line {1, 3, 5, 7, 12}.

The MPM list construction is modified comparing to the regular intra MPM as follows:
PLANAR mode is excluded from the intra-prediction-mode candidate list,
DC mode is added after the 5 neighboring modes and DIMD modes,
The delta angles from ±1 to ±4 added to the already included to the list angular modes.

There are 5×10=50, which are sorted in the ascending order by SAD cost in the template area shown in FIG. 13. Since the extended reference line starts from reference line 1, the area covered by reference line 0 is used for the template cost calculation. The 20 combinations with the least SAD cost form the candidate list.
2.1.13 Intra prediction fusion

In this test, intra prediction is formed by fusion intra prediction derived from different reference lines as follows:
For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.
For TIMD mode with blending, pₗᵢₙₑ is used for the 1^{st} mode (w₀=1, w₁=0) and pₗᵢₙₑ₊₁ is used for the 2^{nd} mode (w₀=0, w₁=1).
For DIMD mode with blending, the number of predictors selected for a weighted average is increased from 3 to 6.

Intra prediction fusion is applied to luma blocks when angular intra mode has non-integer slope (required reference samples interpolation) and the block size is greater than 16, it is used with MRL and not applied for ISP coded blocks. PDPC is applied for the intra prediction mode using the closest to the current block reference line.
2.1.14 IntraTMP adaptation for camera-captured content

In the test, IntraTMP is enabled for camera-captured content with the speedup method applied, where the search area is sub-sampled by a factor of 2, which reduces the template matching search by a factor of 4. After finding the best match, a second refinement process is performed in which another template matching search is performed around the best match with a reduced search range defined as min (width, height)/2 of the current block.
2.2 Inter prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction,
Merge mode with MVD (MMVD),
Symmetric MVD (SMVD) signalling,
Affine motion compensated prediction,
Subblock-based temporal motion vector prediction (SbTMVP),
Adaptive motion vector resolution (AMVR),
Motion field storage: 1/16th luma sample MV storage and 8×8 motion field compression,
Bi-prediction with CU-level weight (BCW),
Bi-directional optical flow (BDOF),
Decoder side motion vector refinement (DMVR),
Geometric partitioning mode (GPM),
Combined inter and intra prediction (CIIP).

The following text provides the details on those inter prediction methods specified in VVC.
2.2.1 Extended merge prediction

In VVC, the merge candidate list is constructed by including the following five types of candidates in order:
1) Spatial MVP from spatial neighbour CUS,
2) Temporal MVP from collocated CUs,
3) History-based MVP from an FIFO table,
4) Pairwise average MVP,
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.
2.2.1.1 Spatial candidates derivation

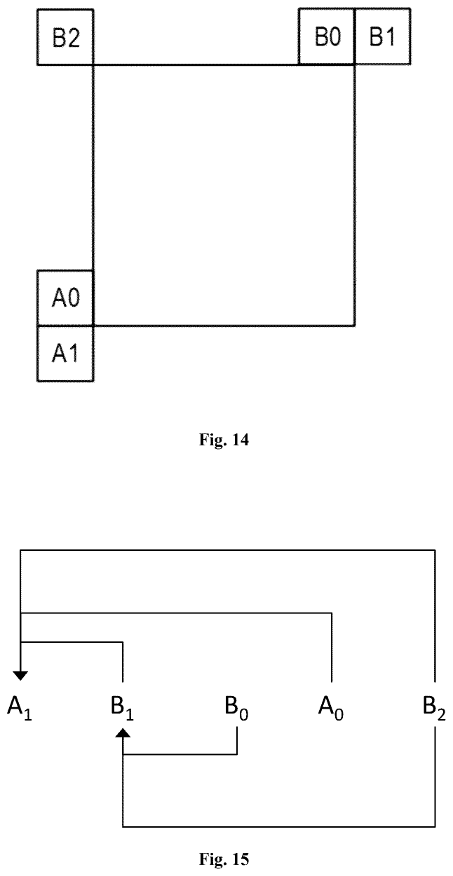

FIG. 14 illustrates positions of spatial merge candidate.

The derivation of spatial merge candidates in VVC is same to that in HEVC except the positions of first two merge candidates are swapped. A maximum of four merge candidates are selected among candidates located in the positions depicted in FIG. 14. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead, only the pairs linked with an arrow in FIG. 15 are considered and a candidate is only added to the list if the corresponding candidate used for redundancy check has not the same motion information. FIG. 15 illustrates candidate pairs considered for redundancy check of spatial merge candidates.

### Temporal Candidates Derivation

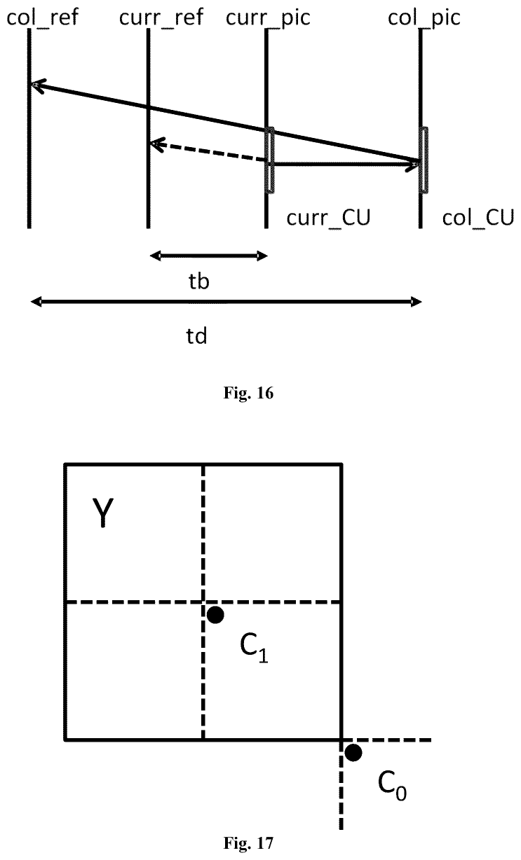

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. FIG. 16 illustrates motion vector scaling for temporal merge candidate. The scaled motion vector for temporal merge candidate is obtained as illustrated by the dotted line in FIG. 16, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 17 which illustrates candidate positions for temporal merge candidate, C₀ and C₁. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate. To reduce the number of redundancy check operations, the following simplifications are introduced:
1. Number of HMPV candidates is used for merge list generation is set as (N<=4)? M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.
2.2.1.2 Merge estimation region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.
2.2.1.3 Merge mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

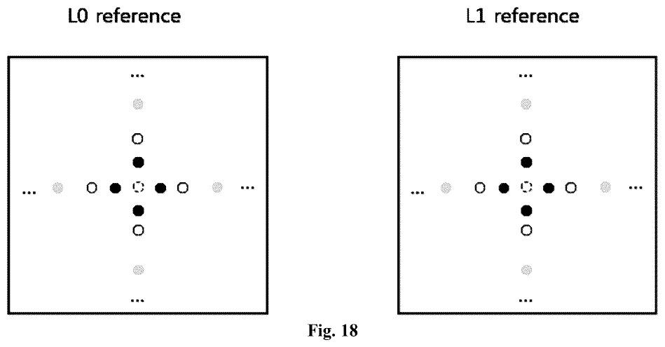

Distance index specifies motion magnitude information and indicate the pre-defined offset from the starting point. FIG. 18 illustrates MMVD search point. As shown in FIG. 18, an offset is added to either horizontal component or vertical component of starting MV. The relation of distance index and pre-defined offset is specified in Table 2.

TABLE 2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 3 specifies the sign of MV offset added to the list0 MV component of starting MV and the sign for the list1 MV has opposite value.

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

2.2.1.4 Bi-prediction with CU-level weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{b i - pred} = ( ( 8 - w ) * {P}_{0} + w * {P}_{1} + 4 ) ≫ 3 \qquad ( 2 - 1 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.
2.2.1.5 Bi-directional optical flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the ATMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0, 1, of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \qquad ( 2 - 2 )$$

$$\frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )$$

where I^{(k)}(i, j) are the sample value at coordinate (i, j) of the prediction signal in list k, k=0, 1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) ) \qquad ( 2 - 3 )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \qquad ( 2 - 4 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0 \qquad ( 2 - 5 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

where

$${S}_{2 , m} = {S}_{2} >> {n}_{{S}_{2}} , {S}_{2 , s} = {S}_{2} \& ( {2}^{{n}_{{s}_{2}}} - 1 ) , {th}_{BIO}^{′} = {2}^{max ( 5 , BD - 7 )} .$$

└⋅┘ is the floor function, and n_{S}_{₂}=12. Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 6 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift \qquad ( 2 - 7 )$$

These values are selected such that the multipliers in the BDOF process do not exceed 15-bit, and the maximum bit-width of the intermediate parameters in the BDOF process is kept within 32-bit.

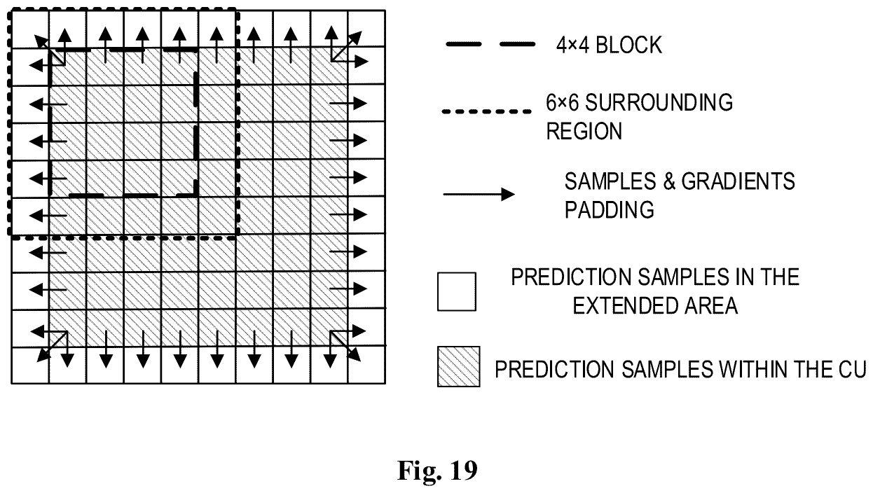

In order to derive the gradient values, some prediction samples I^{(k)}(i, j) in list k (k=0, 1) outside of the current CU boundaries need to be generated. FIG. 19 illustrates extended CU region used in BDOF. As depicted in FIG. 19, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_1x_flag is 1 for either of the two reference pictures, then BDOF is also disabled. When a CU is coded with symmetric MVD mode or CIIP mode, BDOF is also disabled.
2.2.1.6 Symmetric MVD coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.

The decoding process of the symmetric MVD mode is as follows:
1) At slice level, variables BiDirPredFlag, RefIdxSymL0 and RefIdxSymL1 are derived as follows:
   If mvd_l1_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2) At CU level, a symmetrical mode flag indicating whether symmetrical mode is used or not is explicitly signaled if the CU is bi-prediction coded and BiDirPredFlag is equal to 1.

When the symmetrical mode flag is true, only mvp_l0_flag, mvp_l1_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} - {mvdx}_{0} , {mvpy}_{1} - {mvdy}_{0} )\end{matrix} . \qquad ( 2 - 8 )$$

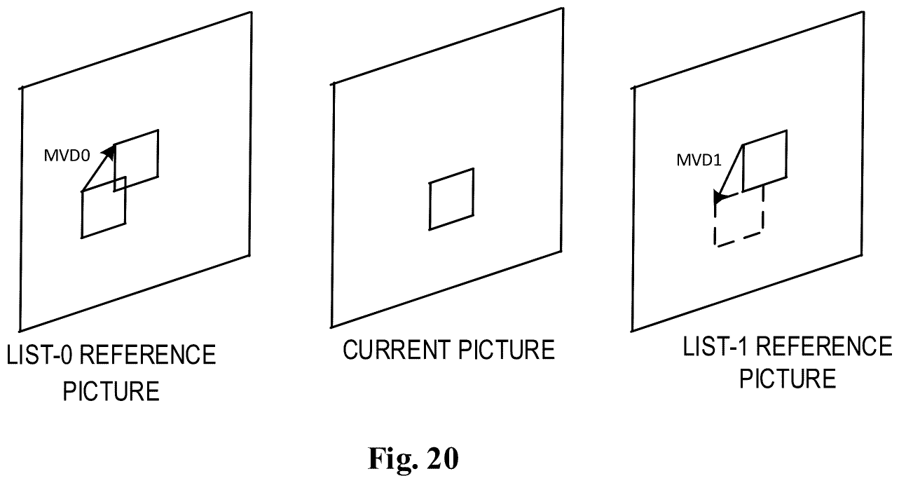

FIG. 20 illustrates an illustration for symmetrical MVD mode.

In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.
2.2.1.7 Decoder side motion vector refinement (DMVR)

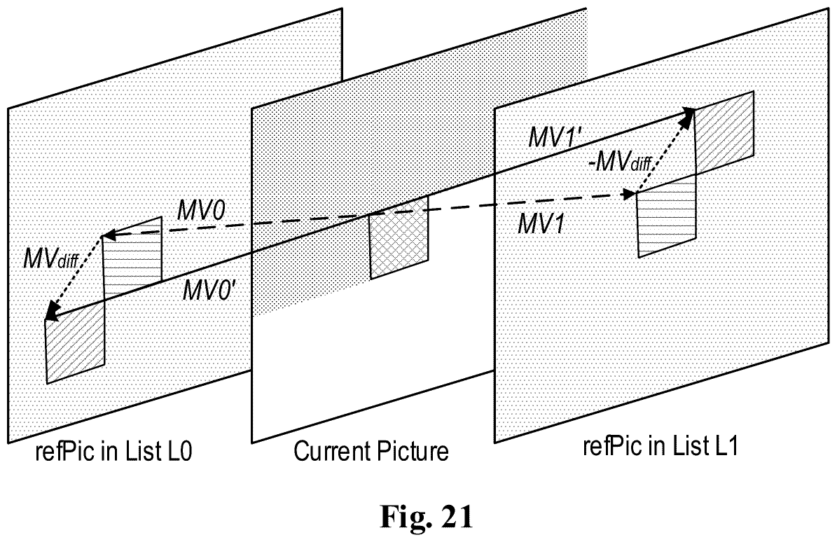

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 21 illustrates decoding side motion vector refinement. As illustrated in FIG. 21, the SAD between the red blocks based on each MV candidate around the initial MV is calculated. The MV candidate with the lowest SAD becomes the refined MV and used to generate the bi-predicted signal.

In VVC, the DMVR can be applied for the CUs which are coded with following modes and features:
CU level merge mode with bi-prediction MV.
One reference picture is in the past and another reference picture is in the future with respect to the current picture.
The distances (i.e. POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset , \qquad ( 2 - 9 )$$

$$MV {1}^{′} = MV 1 - MV\_offset . \qquad ( 2 - 10 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied. In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C \qquad ( 2 - 11 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) , \qquad ( 2 - 12 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) . \qquad ( 2 - 13 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### Bilinear-Interpolation and Sample Padding

In VVC, the resolution of the MVs is 1/16 luma samples. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### Maximum DMVR Processing Unit

When the width and/or height of a CU are larger than 16 luma samples, it will be further split into subblocks with width and/or height equal to 16 luma samples. The maximum unit size for DMVR searching process is limit to 16×16.
2.2.1.8 Combined inter and intra prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + w t * {P}_{intra} + 2 ) ≫ 2. \qquad ( 2 - 14 )$$

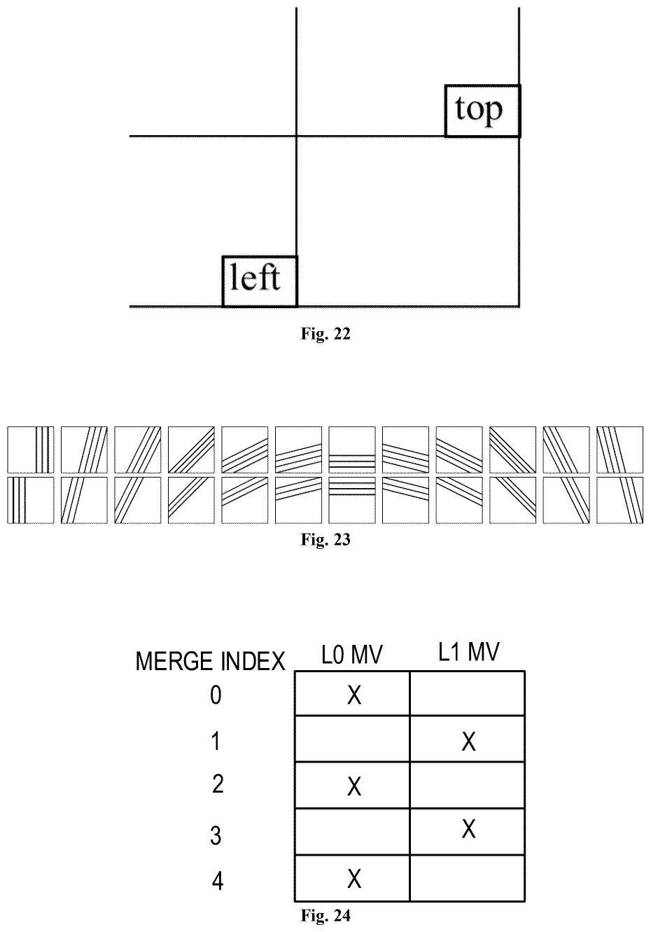

FIG. 22 illustrates top and left neighboring blocks used in CIIP weight derivation.
2.2.1.9 Multi-hypothesis prediction (MHP)

Up to two additional predictors are signalled on top of inter AMVP mode, regular merge mode, and MMVD mode. The resulting overall prediction signal is accumulated iteratively with each additional prediction signal.

$${p}_{n + 1} = ( 1 - {α}_{n + 1} ) {p}_{n} + {α}_{n + 1} {h}_{n + 1} .$$

The weighting factor α is specified according to the following table.

| add_hyp_weight_idx | α |
|---|---|
| 0 | ¼ |
| 1 | −⅛ |

For inter AMVP mode, MHP is only applied if non-equal weight in BCW is selected in bi-prediction mode.
2.2.1.10 Overlap subblock based motion compensation (OBMC)

When OBMC is applied, top and left boundary pixels of a CU are refined using neighboring block's motion information with a weighted prediction.

Conditions of not applying OBMC are as follows:
When OBMC is disabled at SPS level.
When current block has intra mode or IBC mode.
When current block applies LIC.
When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.
2.2.1.11 Local illumination compensation (LIC)

LIC is an inter prediction technique to model local illumination variation between current block and its prediction block as a function of that between current block template and reference block template. The parameters of the function can be denoted by a scale α and an offset β, which forms a linear equation, that is, a*p[x]+β to compensate illumination changes, where p[x] is a reference sample pointed to by MV at a location x on reference picture. When wrap around motion compensation is enabled, the MV shall be clipped with wrap around offset taken into consideration. Since a and B can be derived based on current block template and reference block template, no signaling overhead is required for them, except that an LIC flag is signaled for AMVP mode to indicate the use of LIC.

The local illumination compensation is used for uni-prediction inter CUs with the following modifications.
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.
2.2.1.12 Geometric partitioning mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

When this mode is used, a CU is split into two parts by a geometrically located straight line (FIG. 23). FIG. 23 illustrates examples of the GPM splits grouped by identical angles. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 24. FIG. 24 illustrates uni-prediction MV selection for geometric partitioning mode. In case a corresponding LX motion vector of the n-the extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 15 )$$

$${ρ}_{j} = {ρ}_{x , j} cos ( {φ}_{i} ) + {ρ}_{y , j} sin ( {φ}_{i} ) \qquad ( 2 - 16 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 17 )$$

$${ρ}_{y , j} = \{ \begin{matrix}\pm ( j \times w ) ≫ 2 & i \% 16 = 8 or ( i \% 16 \neq 0 and h \geq w ) \\ 0 & otherwise\end{matrix} \qquad ( 2 - 18 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 2 - 19 )$$

$${w}_{0} ( x , y ) = \frac{Clip 3 ( 0 , 8 , ( wIdxL ( x , y ) + 4 ) ≫ 3 )}{8} \qquad ( 2 - 20 )$$

$${w}_{1} ( x , y ) = 1 - {w}_{0} ( x , y ) . \qquad ( 2 - 21 )$$

The partIdx depends on the angle index i. One example of weigh w₀ is illustrated below.

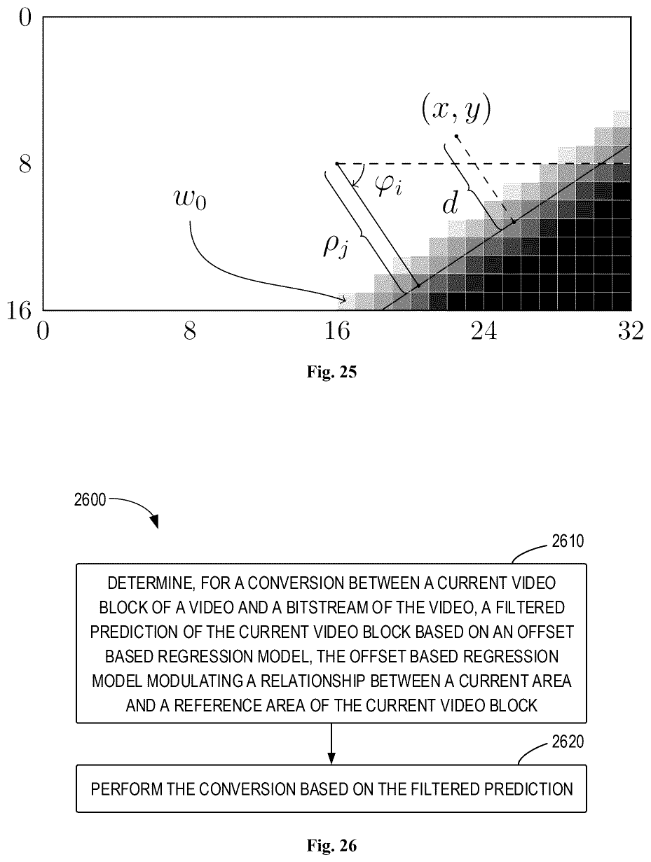

FIG. 25 illustrates exemplified generation of a blending weight w₀ using geometric partitioning mode.

### Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 2 - 22 )$$

where motionIdx is equal to d(4x+2,4y+2). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   GPM with Inter and Intra Prediction (GPM Inter-Intra)

With the GPM inter-intra, pre-defined intra prediction modes against geometric partitioning line can be selected in addition to merge candidates for each non-rectangular split region in the GPM-applied CU. In the proposed method, whether intra or inter prediction mode is determined for each GPM-separated region with a flag from the encoder. When the inter prediction mode, a uni-prediction signal is generated by MVs from the merge candidate list. On the other hand, when the intra prediction mode, a uni-prediction signal is generated from the neighboring pixels for the intra prediction mode specified by an index from the encoder. The variation of the possible intra prediction modes is restricted by the geometric shapes. Finally, the two uni-prediction signals are blended with the same way of ordinary GPM.
2.3 on LIC, AMVP-MERGE, and adaptive DMVR mode

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., AMVP, Merge, SMVD, BDOF, PROF, DMVR, AMVR, TM, Affine, CIIP, GPM, GEO, TPM, MMVD, BCW, HMVP, SbTMVP, and etc.).

In this disclosure, “a two-direction-DMVR” may indicate regular DMVR which refines both L0 and L1 motion vectors, as elaborated in section 2.1.14. Moreover, “a one-direction-DMVR” may indicate a DMVR process which refines either L0 or L1 motion vector only, such as adaptive DMVR elaborated in section 2.1.23.

In the following discussion, LIC parameters may refer to the two parameters (such as a slope parameter “a” and a bias parameter “b”) derived based on a linear model, which is used to map the neighboring samples of current block and the neighboring samples of temporally collocated block (e.g., temporally collocated block may be pointed by the motion vector or a rounded motion vector of the current block). Furthermore, the LIC parameters may be used to estimate the prediction values of samples inside the current video unit.

In the following discussion, the AMVP mode may be regular AMVP mode, affine-AMVP mode, and/or SMVD mode, and/or AMVP-MERGE mode.

It is noted that the terminologies mentioned below are not limited to the specific ones defined in existing standards. Any variance of the coding tool is also applicable.
2.3.1 To tackle the first problem, the following methods are proposed:
   a. It is proposed to support multiple MVD/MV precisions for the AMVP-MERGE mode.
      i. In one example, the supported precision candidates may be the same as those used for the normal AMVP mode, e.g., for non-affine case, half-pel, ¼-pel, 1-pel, 4-pel are applied; for affine case, 1/16-pel, ⅛-pel, ¼-pel are applied.
      ii. In another example, at least one of the supported precision candidates may be different from that used for normal AMVP mode.
   b. For example, the motion vector difference (e.g., MVD) of the AMVP side of an AMVP-MERGE mode may be coded with other precisions in addition to ¼ pel resolution.
      i. For example, the MVD value may be of 4-pel precision.
      ii. For example, the MVD value may be of 1-pel precision.
      iii. For example, the MVD value may be of half-pel precision.
      iv. For example, the MVD value may be of ⅛-pel precision.
      v. For example, the MVD value may be of 1/16-pel precision.
   c. For example, a second interpolation filter (e.g., Y-tap filter such as Y=6) in addition to a first interpolation filter (e.g., X-tap filter such as X=8 or 12) may be used for motion compensation.
      i. For example, when to use the second interpolation filter for an AMVP-MERGE coded block may be dependent on the MVD prediction and/or the final MV precision.
      ii. For example, when the signalled MVD is ½-pel precision and the final MV is also ½-pel precision, the second interpolation filter may be used. Otherwise, the first interpolation filter may be used.
      iii. In one example, the second interpolation filter used in the AMVP-MERGE mode may be the same as that used for the normal AMVP mode (e.g., the one used for the ½-pel precision).
      iv. Alternatively, the second interpolation filter used in the AMVP-MERGE mode may be different from that used for the normal AMVP mode (e.g., the one used for the ½-pel precision).
   d. Alternatively, half-pel MVD precision may not be allowed to be used for AMVP-MERGE mode.
   e. For example, at least one syntax element (e.g., flag and/or parameter index) may be signalled at block level to indicate which motion vector precision is used to code/signal the MVD value and/or MV of an AMVP-MERGE mode coded video unit.
      i. Furthermore, the signalled MVD at any resolution may be converted to an internal precision (e.g., 1/16 pel resolution) for latter procedures such as motion compensation and etc.
2.3.2 To tackle the second problem, the following methods are proposed:
   a. In one example, the prediction unit generated based on AMVP-MERGE mode may be used as an MHP hypotheses.
      i. For example, the AMVP-MERGE mode prediction block may be used as the base hypothesis of an MHP block.
      ii. For example, syntax elements/structure related to MHP hypothesis data (e.g., whether there is additional hypothesis associated with the AMVP-MERGE coded video unit; if there is, AMVP or MERGE based MHP additional hypothesis is used, etc.) may be signalled in the bitstream right after a video unit is identified to be an AMVP-MERGE mode coded video unit.
      iii. For example, an AMVP-MERGE prediction block may be used as an additional hypothesis of an MHP block.
      iv. For example, additional hypothesis of an MHP block may be generated based on an AMVP-MERGE motion candidate.
         1) For example, in such case, syntax elements related to this AMVP-MERGE motion candidate (e.g., which side is AMVP/MERGE coded, reference index of the AMVP side, MVD value for the AMVP side, and/or MVP index of the AMVP side) may be signalled in the multiple hypothesis data structure.
      v. For example, whether LIC is used for an AMVP-MERGE coded additional hypothesis may be inherited from the usage of LIC of the base hypothesis.
         1) For example, if the base hypothesis is LIC coded, the AMVP-MERGE coded additional hypothesis is LIC coded without signalling the usage of the LIC of such additional hypothesis.
         2) Alternatively, if the base hypothesis is NOT LIC coded, the AMVP-MERGE coded additional hypothesis is NOT LIC coded without signalling the usage of the LIC of such additional hypothesis.
      vi. For example, whether LIC is used for an AMVP-MERGE coded hypothesis (base and/or additional hypothesis) may be dependent on the usage of LIC of the merge side of the AMVP-MERGE candidate.
         1) For example, given that a certain AMVP-MERGE candidate is composed of a uni-merge candidate in one side (L0 or L1) and a uni-AMVP candidate in the other side (L1 or L0),
         a. For example, the usage of LIC for such AMVP-MERGE candidate may be inherited from its merge candidate.
         b. For example, if the merge candidate uses LIC, then LIC may be used for the AMVP-MERGE coded prediction block.
      vii. Alternatively, the usage of LIC for an AMVP-MERGE coded hypothesis may be signalling in the bitstream.
2.3.3 To tackle the third problem, the following methods are proposed:
   a. For example, an AMVP-MERGE candidate may be used for one or more of the following coding modes.
      i. CIIP mode (and/or its variants, e.g., regular CIIP, CIIP-PDPC, CIIP-TM, etc).
      ii. MMVD mode (and/or its variants, e.g., regular MMVD, affine MMVD, etc).
      iii. MHP mode (and/or its variants, e.g., MHP base hypothesis, and/or MHP additional hypothesis, etc).
      iv. GPM mode (and/or its variants, e.g., regular GPM, GPM-TM, GPM-MMVD, GPM-Inter-Intra, etc).
   b. For example, an AMVP-MERGE candidate may be firstly refined by a decoder side motion vector refinement process (e.g., TM or DMVR based motion vector refinements), then used for a second coding mode (e.g., such as listed in the above sub-bullet).
   c. For example, AMVP-MERGE candidates may be inserted to another candidate list.
      i. For example, AMVP-MERGE candidates may be inserted to the regular merge candidate list.
         1) For example, AMVP-MERGE candidate may be used for regular merge mode and/or its variants.
         2) For example, AMVP-MERGE candidate may be used for MMVD mode and/or its variants.
         3) For example, AMVP-MERGE candidate may be used for CIIP mode and/or its variants.
         4) For example, AMVP-MERGE candidate may be used for MHP mode and/or its variants.
         5) For example, AMVP-MERGE candidate may be used for GPM mode and/or its variants.
      ii. For example, AMVP-MERGE candidates may be inserted to the regular TM merge candidate list.
         1) For example, AMVP-MERGE candidate may be used for regular TM merge mode and/or its variants.
      iii. Additionally, furthermore, the AMVP-MERGE candidate may be inserted to another prediction list after the original candidates of that prediction list.
   d. For example, AMVP-MERGE candidates may be reordered based on a decoder derived method (through TM or DMVR based cost evaluation), then M of them would be selected to be added to a second candidate list (such as regular merge candidate list, regular TM merge candidate list).
      i. Additionally, furthermore, more than one AMVP-MERGE candidates may be reordered together.
      ii. Alternatively, a first candidate from the first AMVP-MERGE prediction list and a second candidate from the second prediction list may be reordered together.
   e. For example, once an AMVP-MERGE candidate is used for a coding block, extra syntax elements may be signalled specifying the prediction direction (L0 or L1) of the AMVP part, and/or the reference picture index of the selected AMVP candidate, and/or the motion vector predictor index of the selected AMVP candidate, and/or the motion vector difference associated with the AMVP motion vector predictor.
      i. Alternatively, the motion vector predictor index of the AMVP side of an AMVP-MERGE candidate may not be signalled (e.g., it may be selected by a decoder side method through TM or DMVR based cost evaluation).
   f. Alternatively, once an AMVP-MERGE candidate is used, extra syntax element(s) may be signalled specifying the predictor index of the merge candidate.
      i. Alternatively, the motion vector predictor index of the merge side of an AMVP-MERGE candidate may not be signalled (e.g., it may be selected by a decoder side method through TM or DMVR based cost evaluation).
   g. In one example, the merge part of AMVP-MERGE mode may be firstly refined by a decoder side motion vector refinement process (such as TM or DMVR) before generating a AMVP-MERGE candidate.
   h. In one example, the AMVP part of AMVP-MERGE mode may be firstly refined by a decoder side motion vector refinement process (such as TM or DMVR) before generating a AMVP-MERGE candidate.
2.3.4 To tackle the fourth problem, the following methods are proposed:
   a. For example, an adaptive DMVR motion candidate may be used for one or more of the following coding modes.
      i. CIIP mode (and/or its variants, e.g., regular CIIP, CIIP-PDPC, CIIP-TM, etc).
      ii. MMVD mode (and/or its variants, e.g., regular MMVD, affine MMVD, etc).
      iii. MHP mode (and/or its variants, e.g., MHP base hypothesis, and/or MHP additional hypothesis, etc).
      iv. GPM mode (and/or its variants, e.g., regular GPM, GPM-TM, GPM-MMVD, GPM-Inter-Intra, etc).
      v. AMVP mode (and/or its variants, e.g., regular AMVP, SMVD, AMVP-MERGE, affine AMVP, etc).
   b. For example, an adaptive DMVR motion candidate may be firstly refined by a decoder side motion vector refinement process (e.g., TM or DMVR based motion vector refinements), then used for a second coding mode (e.g., such as listed in the above sub-bullet).
   c. For example, when an adaptive DMVR motion candidate is used for an AMVP mode.
      i. The DMVR motion candidate may refer to a motion vector pair contains both L0 and L1 motion vectors, and/or, both L0 and L1 reference picture indexes.
      ii. It may be used as an MVP candidate.
      iii. The candidate index of the DMVR motion candidate (rather than the L0 and L1 motion vector predictor indexes, and L0 and L1 reference picture indexes) may be signalled for the AMVP mode in the bitstream.
      iv. The reference picture index of one prediction direction (L0 or L1) may be signalled for the AMVP mode, and the reference picture index of the other prediction direction (L1 or L0) may be inferred (e.g., according to the DMVR condition).
   d. For example, adaptive DMVR motion candidates may be inserted to another candidate list.
      i. For example, adaptive DMVR motion candidates may be inserted to the regular merge candidate list.
         1) For example, adaptive DMVR motion candidate may be used for regular merge mode and/or its variants.
         2) For example, adaptive DMVR motion candidate may be used for MMVD mode and/or its variants.
         3) For example, adaptive DMVR motion candidate may be used for CIIP mode and/or its variants.
         4) For example, adaptive DMVR motion candidate may be used for MHP mode and/or its variants.
         5) For example, adaptive DMVR motion candidate may be used for GPM mode and/or its variants.
      ii. For example, adaptive DMVR motion candidates may be inserted to the regular TM merge candidate list.
         1) For example, adaptive DMVR motion candidate may be used for regular TM merge mode and/or its variants.
      iii. Additionally, furthermore, the adaptive DMVR motion candidate may be inserted to another prediction list after the original candidates of that prediction list.
   e. For example, adaptive DMVR motion candidates may be reordered based on a decoder derived method (through TM or DMVR based cost evaluation), then M of them would be selected to be added to a second candidate list (such as regular merge candidate list, regular TM merge candidate list).
      i. Additionally, furthermore, more than one adaptive DMVR motion candidates may be reordered together.
      ii. Alternatively, a first candidate from the first adaptive DMVR merge list and a second candidate from the second prediction list may be reordered together.
2.3.5 To tackle the fifth problem, the following methods are proposed:
   a. For example, the enabling/disabling of a first coding tool may be controlled by a second syntax element signalled at a syntax level higher than coding block level.
      i. For example, the syntax level higher than coding block level may indicate sequence level/group of pictures level/picture level/slice level/tile group level, such as in sequence header/picture header/SPS/VPS/DPS/DCI/PPS/APS/slice header/tile group header.
      ii. For example, a single coding tool may be controlled by the second syntax element.
      iii. For example, more than one coding tool may be controlled by the second syntax element.
      iv. For example, the first coding tool may be a prediction mode that utilizes a decoder side motion derivation method (such as AMVP-MERGE mode, etc.).
      v. For example, the second syntax elements may be an SPS/PPS/PH/SH flag specifying whether the decoder side motion derivation methods (such as DMVR and TM and etc.) is allowed or not.
      vi. For example, the second syntax elements may be an SPS/PPS/PH/SH flag specifying whether the decoder side motion vector refinement (such as DMVR and etc.) is allowed or not.
      vii. For example, the second syntax elements may be an SPS/PPS/PH/SH flag specifying whether the decoder side template matching (such as TM, and/or inter TM and etc.) is allowed or not.
2.3.6 About the LIC parameter derivation (e.g., as illustrated in the sixth problem), suppose the linear model used for an LIC coded block is based on at least two parameters: a slope parameter “a” and a bias parameter “b”, and the relationship between the neighboring sample of the current block and the neighboring sample of the temporally collocated block can be represented by “reconTempNeigh=a*reconCurNeigh+b”, in which “reconTempNeigh” denotes the reconstruction/prediction value of the neighboring sample of the temporally collocated block, and “reconCurNeigh” denotes the reconstruction/prediction value of the neighboring sample of the current block, the following methods are proposed:
   a. For example, at least one adjustment factor may be applied to adjust at least one LIC parameter for an LIC model derivation.
      a. For example, the adjustment factor may be signalled/present in the bitstream.
      b. For example, the adjustment factor may be derived at both encoder and decoder.
   b. For example, at least one syntax element (e.g., a syntax parameter, or index, or variable, or offset value, or integer) may be signalled at a video unit level for calculating at least one LIC parameter of at least one LIC model.
      a. For example, the video unit level may be PU/CU/block level.
         i. For example, furthermore, the video unit level may be sequence/group of pictures/picture/slice/tile group/PB/TB/CB/PU/TU/CU/VPDU/CTU/CTU row/slice/tile/sub-picture level.
      b. For example, the syntax element(s) may be used to adjust the value of at least one LIC parameter of at least one LIC model.
         i. For example, the syntax element(s) may be used as indicator(s) for adjustment factor(s).
         ii. Alternatively, the syntax element(s) may be used to represent/indicate the value of at least one LIC parameter.
         iii. For example, one indicator may be signalled to adjust the parameters of one LIC model.
      c. For example, the derivation of LIC parameters may be based on both decoder derived methods and the signalled syntax element.
      d. For example, the syntax element may be an indicator of an integer.
         i. For example, the value of the syntax element may be in the range of [−N, +N], for example, N=4.
         ii. For example, the LIC parameter may be directly derived based the integer.
      e. For example, the syntax element may be an indictor of an index.
         i. For example, according to the first value of the index, a second value may be derived from a (pre-defined) look-up-table for the LIC parameter derivation.
      f. For example, how many syntax elements are signalled may be dependent on how many linear/LIC model is used for the video unit (e.g., a coding block).
         i. For example, if M LIC models are used for the video unit, then M syntax elements may be signalled associated with the video unit.
   c. For example, the prediction sample value derivation of an LIC coded video unit may be conducted based on an updated model: ValueAfter=a′*ValueBefore+b′, wherein a′=a+Delta, b′=b−Delta*funcD.
      a. For example, the updated model may be used to estimate/derive the prediction samples inside the current block.
         i. Alternatively, the updated model may be used to modulate the relationship between neighboring samples of the current block and neighboring samples of temporally collocated block.
      b. For example, “Delta” may be a slope adjustment/offset value of an LIC model.
         i. For example, at least one indictor of “Delta” may be signalled in the bitstream.
         ii. Alternatively, the value of “Delta” may be derived based on decoded information (e.g., decoded sample values, decoded prediction modes of neighboring/reference blocks).
         iii. For example, “Delta” may be an integer.
         iv. For example, “Delta” may be an integer in the range of [−N, +N], for example, N=4.
         v. For example, “Delta” may be a number/value/integer/constant/variable derived from an index on a look-up-table.
      c. For example, “funcD” may be calculated by averaging the reconstruction/prediction values of all available/appropriate/possible neighboring samples of the current block (or, all available/appropriate/possible neighboring samples of the temporally collocated block).
         i. For example, “funcD” may be calculated by averaging neighboring/reference samples from both Intra and Inter coded blocks.
         1. Alternatively, “funcD” may be calculated by averaging neighboring/reference samples from Inter coded blocks only.
         ii. For example, “funcD” may be calculated by averaging all available neighboring/reference samples located at the left and/or above side of the current block and/or temporally collocated block.
         1. Alternatively, only partial (e.g., neighboring the first top-left M×M unit, such as M=16 or 8 or 4 or 32) of such samples may be considered.
         iii. For example, (the neighboring samples of) the temporally collocated block may be retrieved/pointed by the block motion vector (or its variant).
         1. Alternatively, (the neighboring samples of) the temporally collocated block may be retrieved/pointed by a rounded block motion vector (e.g., rounded to integer-pel precision).
         iv. For example, the averaging process may be processed with (or without) a rounding factor.
         v. Alternatively, the averaging process may be replaced by other function such as summing up, etc.
      d. For example, the updated model (e.g., with adjustment) may be used/allowed for all LIC coded blocks.
         i. Alternatively, the updated model may be used/allowed for a certain kind of LIC coded blocks.
         1. For example, the “certain kind” may be determined based on the available/appropriate/possible neighboring samples (such as both left and above neighboring samples are available, or only left neighboring are available, or only above neighboring are available, etc.).
         2. For example, the “certain kind” may be determined based on the prediction mode (such as AMVP coded or MERGE coded, uni-prediction or bi-prediction, etc.).
         ii. Alternatively, only if both left and above reference samples are available/appropriate/possible for the video unit, the updated model may be used/allowed.
         iii. Alternatively, only if the video unit is uni-directional predicted, the updated model may be used/allowed.
   d. The information of the adjustment for LIC or CCLM or MM-CCLM may be coded in a predictive way.
   e. The information of the adjustment for LIC or CCLM or MM-CCLM may be coded with at least one context model.
      a. The context model may depend on coding information.
      b. Alternatively, it may be coded in a bypass way.
   f. For example, the neighboring/reference samples used to derive the LIC model parameters may not be all available/appropriate/possible neighboring/reference samples from the left side and above side adjacent to the coding block and temporally collocated block.
      a. For example, it may refer to neighboring/reference samples from both Intra and Inter coded blocks.
         i. Alternatively, it may refer to neighboring/reference samples from Inter coded blocks only.
      b. For example, it may refer to neighboring/reference samples located at the left (or above) side of the current block and/or temporally collocated block.
         i. Alternatively, only partial (e.g., neighboring the first top-left M×M unit, such as M=16 or 8 or 4 or 32) of such samples may be considered.
      c. For example, (the neighboring samples of) the temporally collocated block may be retrieved/pointed by the block motion vector (or its variant).
         i. Alternatively, (the neighboring samples of) the temporally collocated block may be retrieved/pointed by a rounded block motion vector (e.g., rounded to integer-pel precision).
   g. For example, whether to apply/allow the adjustment (e.g., the updated model) for a video unit may be dependent on coded information.
      a. For example, both original model (without adjustment) and updated model (with adjustment) may be used/allowed.
         i. Alternatively, only the updated model would be used/allowed.
      b. For example, whether to allow (or apply) the adjustment based LIC model updating, may be signalled in the bitstream.
         i. For example, it may be signalled at (at least) one video unit level such as sequence/group of/slice pictures/picture/tile group/PB/TB/CB/PU/TU/CU/VPDU/CTU/CTU row/slice/tile/sub-picture level.
      c. For example, whether to allow (or apply) the adjustment based LIC model updating, may be derived at both encoder and decoder sides.
2.3.7 Whether to and/or how to apply the adjustment for CCLM, MM-CCLM or LIC may depend on coding information, such as block dimensions, coding mode, (transformed) residuals, transforms etc.
   a. For example, the adjustment may not be applied if the width and/or height and/or size of the block is smaller than a threshold.
2.3.8 About the signalling and determination of LIC (e.g., as illustrated in the seventh problem), the following methods are proposed:
   a. For example, the LIC flag at a video unit level (e.g., CU/PU level LIC flag) may not be signalled but derived at both encoder and decoder sides.
      a. For example, the CU/PU level LIC flag for an AMVP coded block may not be signaled.
      b. For example, the CU/PU level LIC flag for an Affine AMVP coded block may not be signaled.
      c. For example, the CU/PU level LIC flag for an AMVP-MERGE coded block may not be signaled.
   b. For example, whether or to use LIC for a video unit may be dependent on coded information (e.g., decoder derived methods).
      a. For example, LIC flag at video unit level may be implicit derived at both encoder and decoder sides.
         i. For example, the CU/PU level LIC flag for a non-merge (such as AMVP, and/or affine AMVP) coded block may be implicit derived.
         ii. For example, the CU/PU level LIC flag for a merge (and/or its variants such as TM, BM, MHP, ADMVR, CIIP, GPM, sbTMVP, Affine Merge, etc.) coded block may be implicit derived.
         iii. For example, the implicit derivation may be based on decoder derived methods.
         iv. For example, the implicit derivation may be based on template matching.
         v. For example, the implicit derivation may be based on bilateral matching.
      b. For example, decoder derived costs/errors/distortions may be calculated for both non-LIC and LIC cases, and the one with less cost/error/distortion is determined as the coding method used for the video unit.
         i. For example, template (and/or bilateral) matching costs may be calculated for LIC coded video unit and non-LIC coded video unit, respectively.
         ii. For example, the costs/errors/distortions are derived by neighboring samples and/or reference samples temporally (collocated) in the reference pictures.
         iii. For example, the costs/errors/distortions are not derived by current block samples in the current picture.
      c. For example, the coded information used for LIC mode may be neighboring/reference samples from both Intra and Inter coded blocks.
         i. Alternatively, the coded information may be neighboring/reference samples from Inter coded blocks only.
      d. For example, the coded information used for LIC mode may be all available neighboring/reference samples located at the left and/or above side of the current block and/or temporally collocated block.
         i. Alternatively, only partial (e.g., neighboring the first top-left M×M unit, such as M=16 or 8 or 4 or 32) of such samples may be considered.
      e. For example, the temporally collocated block may be retrieved/pointed by the block motion vector (or its variant).
         i. Alternatively, the temporally collocated block may be retrieved/pointed by a rounded block motion vector (e.g., rounded to integer-pel precision).
   c. For example, the merge index of an LIC coded merge block may not be signalled (e.g., derived at both encoder and decoder).
      a. For example, the motion (e.g., motion vector, reference index, prediction direction, etc) of the LIC coded merge block may be derived at both encoder and decoder sides.
      b. For example, multiple template (and/or bilateral) matching costs/errors/distortions may be calculated for all (or multiple, or pre-defined partial) available/possible/appropriate merge candidates, respectively. The one with minimum cost/error/distortion is determined as the motion used for the video unit.
         i. For example, the template is constructed by neighboring samples and/or reference samples temporally (collocated) in the reference pictures.
         ii. For example, the template is not constructed by current block samples in the current picture.
         iii. For example, the template is constructed with samples without LIC.
         iv. For example, the template is constructed with samples with LIC.
   d. For example, a best LIC parameter set (such as a and b computed by least square fitting methods) may be determined from more than one set of LIC parameters.
      a. For example, more than one set of LIC parameters may be appropriate for an LIC coded video unit.
      b. For example, which LIC parameter set is used for the video unit may be derived at both encoder and decoder sides.
         i. Alternatively, a syntax element (e.g., an index) may be signalled specifying the LIC parameter set used for the video unit.
      c. For example, multiple template (and/or bilateral) matching costs/errors/distortions may be calculated for all appropriate sets of LIC parameters, respectively. The one with minimum cost/error/distortion is determined as the LIC parameter set used for the video unit.
         i. For example, the template is constructed by neighboring samples and/or reference samples temporally (collocated) in the reference pictures.
         ii. For example, the template is not constructed by current block samples in the current picture.

### General

2.3.9 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
2.3.10 Whether to and/or how to apply the disclosed methods above may be signalled at PB/TB/CB/PU/TU/CU/VPDU/CTU/CTU row/slice/tile/sub-picture/other kinds of region contain more than one sample or pixel.
2.3.11 Whether to and/or how to apply the disclosed methods above may be dependent on coded information, such as block size, colour format, single/dual tree partitioning, colour component, slice/picture type.
3 Problems

There are several issues in the existing video coding techniques, which would be further improved for higher coding gain.
1. In ECM-7.0, intraTMP is applied for both camera-captured videos and screen content videos. Template matching is used in intraTMP mode, in order to find a best prediction block with minimum SAD between current template and reference template. The same process is applied at the decoder side. However, the prediction searched from decoder side may not be accurate for high coding efficiency.
2. In ECM-7.0, LIC is applied to compensate the local illuminance changes between current block and reference block. A linear model Luma_{cur}=a*Luma_{ref}+b is built to modulate the relationship of luma samples between current area and reference area. However, the linear model may be further improved.
4 Detailed Solutions

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.
4.1 About the derivation of final prediction of an intraTMP block and related issues (e.g., the first problem), the following methods are proposed:
   a. For example, an offset based linear/non-linear/polynomial regression model may be used to modulate the relationship between current area and reference area, and a filtered prediction block may be generated based on such model.
      a. Assume a final sample in the current area is calculated by samp Val=a₀Y₀+a₁Y₁+a₂Y₂+a₃Y₃+ . . . +aᵢYᵢ+aᵢ₊₁B, wherein Y₀ . . . Yᵢ represents values based on samples in the reference area, B represent a bias term, a₀ . . . aᵢ₊₁ represent filter coefficients, the value of Yᵢ may be derived by subtracting an offset from a reference sample value.
         i. For example, the offset may be derived based on reference sample(s) located at a pre-defined position(s).
         ii. For example, the offset may be derived based on average/mean/mid/max/min value of samples within the reference area.
         iii. For example, the offset may be equal to 0.
         iv. For example, the bias B may be equal to a variable based on bitDepth of the video sequence, e.g., 512 for 10-bit content and 256 for 8-bit content.
         1. For example, the bias B may be equal to 1<<(bitDepth−1), wherein bitDepth represents the internal bit depth of the samples of the luma and chroma arrays.
         2. Alternatively, the bias B may be equal to 0.
         v. For example, Y₀ to Yᵢ may represent multiple samples neighboring to each other, such as Y₀ locates at the center and surrounded by Y₁ . . . . Yᵢ above/bottom/left/right to Y0.
         vi. Alternatively, Y₀ to Yᵢ may represent samples in different prediction block candidates, wherein there may be in total i+1 prediction candidates.
         vii. Alternatively, Y₀ to Yᵢ may represent samples in different reference lines, wherein there may be in total i+1 reference lines.
         viii. Alternatively, Y₀ to Yᵢ may represent samples in different column/rows within the template, wherein there may be in total i+1 column/rows in the template.
         ix. For example, the filter coefficients a₀ to aᵢ₊₁ may be derived based on LDL decomposition, or gaussian elimination, or least square, of LU decomposition, or Cholesky decomposition, etc.
   b. For example, a list of filtered prediction block candidates may be generated, and which one is used as the final filtered prediction block may be signalled in the bitstream.
      a. For example, the list may be reordered based on template cost.
      b. For example, N out of M (such as N<M) candidates may be selected first and then choose a final filtered prediction among those N candidates.
         i. For example, the selection of the N candidates may be performed based on template cost.
      c. For example, a syntax parameter (e.g., a candidate index) may be signalled at block level.
      d. Alternatively, a final filtered prediction block may be implicitly determined based on template cost (e.g., SAD, SATD, mean removal SAD, offset removal SAD, etc.).
   c. For example, multiple filtered prediction blocks may be fused together and used as the final prediction of the current block.
      a. For example, the blending weights among different filtered prediction blocks may be determined based on SAD/SATD cost.
      b. For example, the blending weights among different filtered prediction blocks may be pre-defined fixed values.
      c. For example, the blending weights among different filtered prediction blocks may be determined based on LDL decomposition, or LU decomposition, or gaussian elimination.
   d. For example, whether to apply fusion or filtering for final prediction block generation may be signalled in the bitstream.
4.2 About the LIC model and related issues (e.g., the second problem), the following methods are proposed:
   a. For example, LIC may be applied based on a linear/non-linear/polynomial regression model.
      a. For example, a linear/non-linear/polynomial regression model may be used to modulate the relationship between current template/reference/block/area and reference template/reference/block/area for LIC.
      b. For example, the linear/non-linear/polynomial regression model for LIC may be represented as: samp Val=a₀Y₀+a₁Y₁+a₂Y₂+a₃Y₃+ . . . +aᵢYᵢ+aᵢ₊₁B, wherein Y₀ . . . . Yᵢ represents values based on samples in the reference area, B represent a bias term, a₀ . . . aᵢ₊₁ represent filter coefficients, the value of Yᵢ may be derived by subtracting an offset from a reference sample value.
         i. For example, the offset may be derived based on reference sample(s) located at a pre-defined position(s).
         ii. For example, the offset may be derived based on average/mean/mid/max/min value of samples within the reference area.
         iii. For example, the offset may be equal to 0.
         iv. For example, the bias B may be equal to a variable based on bitDepth of the video sequence, e.g., 512 for 10-bit content and 256 for 8-bit content.
         1. Alternatively, the bias B may be equal to 0.
         v. For example, Y₀ to Yᵢ may represent multiple samples neighboring to each other, such as Y₀ locates at the center and surrounded by Y₁ . . . . Yᵢ above/bottom/left/right to Y0.
         vi. Alternatively, Y₀ to Yᵢ may represent samples in different reference lines, wherein there may be in total i+1 reference lines.
         vii. Alternatively, Y₀ to Yᵢ may represent samples in different column/rows within the template, wherein there may be in total i+1 column/rows in the template.
         viii. For example, the model coefficients may be solved by MSE minimization between current template and reference template.
         1. For example, the filter coefficients a₀ to aᵢ₊₁ may be derived based on LDL decomposition, or gaussian elimination, or least square, of LU decomposition, or Cholesky decomposition, etc.
   b. For example, the template size for LIC may be larger than one row and/or one column of samples.
      a. For example, the LIC prediction may be derived based on more than one row/column neighboring samples adjacent to the current block and/or reference block.
4.3 For example, intra luma fusion may be applied based on more than two reference lines.
   a. For example, intra luma fusion may be applied based on a linear/non-linear/polynomial regression model.
   b. For example, the weights of different predictions from different reference lines may be calculated based on LDL decomposition, or gaussian elimination, or least square, of LU decomposition, or Cholesky decomposition, etc.
4.4 For example, intra chroma fusion may be applied based on more than two reference lines.
   c. For example, intra chroma fusion may be applied based on a linear/non-linear/polynomial regression model.
   d. For example, the weights of different predictions from different reference lines may be calculated based on LDL decomposition, or gaussian elimination, or least square, of LU decomposition, or Cholesky decomposition, etc.
4.5 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
4.6 Whether to and/or how to apply the disclosed methods above may be signalled at PB/TB/CB/PU/TU/CU/VPDU/CTU/CTU row/slice/tile/sub-picture/other kinds of region contain more than one sample or pixel.
4.7 Whether to and/or how to apply the disclosed methods above may be dependent on coded information, such as block size, colour format, single/dual tree partitioning, colour component, slice/picture type.

More details will be further discussed below. FIG. 26 illustrates a flowchart of a method 2600 for video processing in accordance with embodiments of the present disclosure. The method 2600 is implemented for a conversion between a current video block of a video and a bitstream of the video.

At block 2610, a filtered prediction of the current video block is determined based on an offset based regression model. The offset based regression model modulates a relationship between a current area and a reference area of the current video block. That is, an offset based linear/non-linear/polynomial regression model may be used to modulate the relationship between current area and reference area, and a filtered prediction block may be generated based on such model.

At block 2620, the conversion is performed based on the filtered prediction. In some embodiments, the conversion includes encoding the current video block into the bitstream. Alternatively, or in addition, in some embodiments, the conversion includes decoding the current video block from the bitstream.

The method 2600 enables determining a filtered prediction block based on an offset based regression model. The coding efficiency and/or coding effectiveness can thus be improved.

In some embodiments, the offset based regression model comprises at least one of: an offset based linear regression model, an offset based non-linear regression model, or an offset based polynomial regression model.

In some embodiments, the current video block comprises an intra template matching prediction (intraTMP) block, and the filtered prediction is a final prediction of the current video block.

In some embodiments, determining the filtered prediction comprises: determining a plurality of samples in the reference area; determining a plurality of values based on the plurality of samples and an offset; determining a final sample in the current area based on a weighted sum of the plurality of values and a bias value; and determining the filter prediction based on the final sample. It is assumed that a final sample in the current area is calculated by samp Val=a₀Y₀+a₁Y₁+a₂Y₂+a₃Y₃+ . . . +aᵢYᵢ+aᵢ₊₁B, wherein Y₀ . . . . Yᵢ represents values based on samples in the reference area, B represent a bias term, a₀ . . . aᵢ₊₁ represent filter coefficients, the value of Yᵢ may be derived by subtracting an offset from a reference sample value.

In some embodiments, the plurality of values is determined by subtracting the offset from the plurality of samples. For example, the value of Yᵢ may be derived by subtracting an offset from a reference sample value.

In some embodiments, the weighted sum is determined based on a plurality of filter coefficients for the plurality of values and the bias value.

In some embodiments, the plurality of filter coefficients is determined based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool.

In some embodiments, the offset is determined based on at least one reference sample located at at least one predefined position.

In some embodiments, the offset is determined based on a metric value of samples within the reference area.

In some embodiments, the metric value comprises one of: an average value, a mean value, a middle value, a maximum value or a minimum value.

In some embodiments, the offset is zero.

In some embodiments, the bias value is determined based on a bit depth of a video sequence of the video. In an example, the bit depth is 10-bit, and the bias value is 512. In another example, the bit depth is 8-bit, and the bias value is 256.

In some embodiments, the bias value is determined by: 1<<(bitDepth−1), where bitDepth denotes an internal bit depth of s sample of at least one of: a luma array or a chroma array, <<denotes an arithmetic left shift operation.

In some embodiments, the bias value is zero. For example, the bias B may be equal to 0.

In some embodiments, the plurality of samples is neighboring to each other.

In some embodiments, the plurality of samples comprises a first sample at a center of the reference area, a second sample above to the first sample, a third sample bottom to the first sample, a fourth sample left to the first sample, and a fifth sample right to the first sample. For example, Y₀ to Yᵢ may represent multiple samples neighboring to each other, such as Y₀ locates at the center and surrounded by Y₁ . . . Yᵢ above/bottom/left/right to Y0.

In some embodiments, the plurality of samples is in a plurality of prediction candidates of the current video block. The number of the plurality of samples may be equal to the number of the plurality of prediction candidates.

In some embodiments, the plurality of samples is in a plurality of reference lines of the current video block. The number of the plurality of samples may be equal to the number of the plurality of reference lines.

In some embodiments, the plurality of samples is in a plurality of columns or rows within a template of the current video block. The number of the plurality of samples may be equal to the number of the plurality of columns or rows.

In some embodiments, a list of filtered prediction candidates of the current video block is determined, an indication in the bitstream indicating the filtered prediction in the list of filtered prediction candidates. For example, a list of filtered prediction block candidates may be generated, and which one is used as the final filtered prediction block may be signalled in the bitstream.

In some embodiments, the list of filtered prediction candidates is reordered based on template cost.

In some embodiments, a first number of filtered prediction candidates are selected from the list of filtered prediction candidates, and the filtered prediction is selected from the first number of filtered prediction candidates, the first number being less than a total number of candidates in the list of filtered prediction candidates. For example, N out of M (such as N<M) candidates may be selected first and then choose a final filtered prediction among those N candidates.

In some embodiments, the first number of filtered prediction candidates are selected based on template costs of the list of filtered prediction candidates.

In some embodiments, the indication comprises a syntax parameter included at a block level in the bitstream. For example, the syntax parameter may be an index of a candidate.

In some embodiments, a list of filtered prediction candidates of the current video block is determined, and the filtered prediction is determined based on template costs of the filtered prediction candidates in the list.

In some embodiments, a template cost of a filtered prediction candidate comprises one of: a sum of absolute differences (SAD), a sum of absolute transformed differences (SATD), a mean removal SAD, or an offset removal SAD.

In some embodiments, determining the filtered prediction comprises: determining a plurality of filtered prediction candidates; and determining the filtered prediction of the current video block based on a fusion of the plurality of filtered prediction candidates. For example, multiple filtered prediction blocks may be fused together and used as the final prediction of the current block.

In some embodiments, the fusion is determined based on blending weights of the plurality of filtered prediction candidates, the blending weights being determined based on a sum of absolute differences (SAD) cost or a sum of absolute transformed differences (SATD) cost. That is, the blending weights among different filtered prediction blocks may be determined based on SAD/SATD cost.

In some embodiments, the fusion is determined based on blending weights of the plurality of filtered prediction candidates, the blending weights being predefined fixed values. That is, the blending weights among different filtered prediction blocks may be pre-defined fixed values.

In some embodiments, the fusion is determined based on blending weights of the plurality of filtered prediction candidates, the blending weights being determined based on at least one of: an LDL decomposition, an LU decomposition, or a Gaussian elimination. That is, he blending weights among different filtered prediction blocks may be determined based on LDL decomposition, or LU decomposition, or gaussian elimination.

In some embodiments, whether to apply a fusion or a filtering for a final prediction of the current video block is included in the bitstream. For example, whether to apply fusion or filtering for final prediction block generation may be signalled in the bitstream.

According to further embodiments of the present disclosure, a non-transitory computer-readable recording medium is provided. The non-transitory computer-readable recording medium stores a bitstream of a video which is generated by a method performed by an apparatus for video processing. In the method, a filtered prediction of a current video block of the video is determined based on an offset based regression model The offset based regression model modulates a relationship between a current area and a reference area of the current video block. The bitstream is generated based on the filtered prediction.

According to still further embodiments of the present disclosure, a method for storing bitstream of a video is provided. In the method, a filtered prediction of a current video block of the video is determined based on an offset based regression model The offset based regression model modulates a relationship between a current area and a reference area of the current video block. The bitstream is generated based on the filtered prediction. The bitstream is stored in a non-transitory computer-readable recording medium.

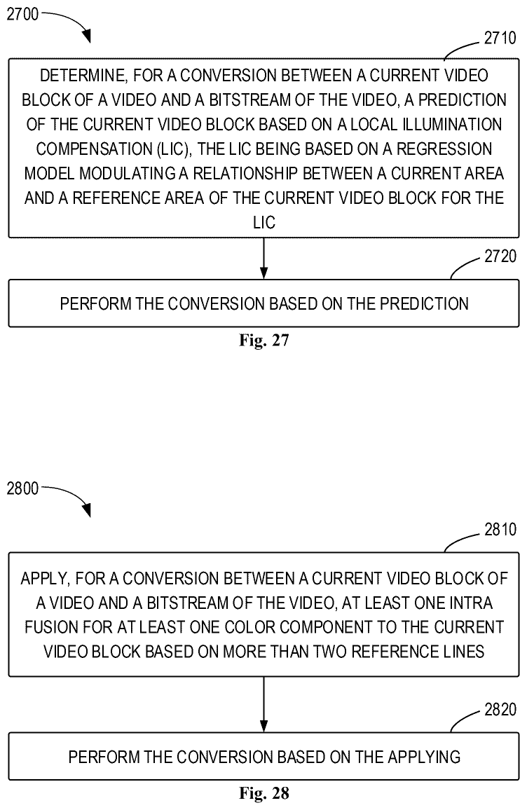

FIG. 27 illustrates a flowchart of a method 2700 for video processing in accordance with embodiments of the present disclosure. The method 2700 is implemented for a conversion between a current video block of a video and a bitstream of the video.

At block 2710, a prediction of the current video block is determined based on a local illumination compensation (LIC). The LIC is based on a regression model modulating a relationship between a current area and a reference area of the current video block for the LIC.

At block 2720, the conversion is performed based on the prediction. In some embodiments, the conversion includes encoding the current video block into the bitstream. Alternatively, or in addition, in some embodiments, the conversion includes decoding the current video block from the bitstream.

The method 2700 enables determining a prediction of the block by using an LIC based on a regression model. The coding efficiency and/or coding effectiveness can thus be improved.

In some embodiments, the regression model comprises at least one of: a linear regression model, a non-linear regression model, or a polynomial regression model.

In some embodiments, determining the prediction comprises: determining a plurality of samples in the reference area; determining a plurality of values based on the plurality of samples and an offset; determining a final sample in the current area based on a weighted sum of the plurality of values and a bias value; and determining the prediction based on the final sample.

In some embodiments, the plurality of values is determined by subtracting the offset from the plurality of samples.

In some embodiments, the weighted sum is determined based on a plurality of filter coefficients for the plurality of values and the bias value.

In some embodiments, the plurality of filter coefficients is determined based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool.

In some embodiments, the offset is determined based on at least one reference sample located at at least one predefined position.

In some embodiments, the offset is determined based on a metric value of samples within the reference area.

In some embodiments, the metric value comprises one of: an average value, a mean value, a middle value, a maximum value or a minimum value.

In some embodiments, the offset is zero.

In some embodiments, the bias value is determined based on a bit depth of a video sequence of the video. In an example, the bit depth is 10-bit, and the bias value is 512. In another example, the bit depth is 8-bit, and the bias value is 256.

In some embodiments, the bias value is zero.

In some embodiments, the plurality of samples is neighboring to each other.

In some embodiments, the plurality of samples comprises a first sample at a center of the reference area, a second sample above to the first sample, a third sample bottom to the first sample, a fourth sample left to the first sample, and a fifth sample right to the first sample.

In some embodiments, the plurality of samples is in a plurality of reference lines of the current video block.

In some embodiments, the number of the plurality of samples is equal to the number of the plurality of reference lines.

In some embodiments, the plurality of samples is in a plurality of columns or rows within a template of the current video block.

In some embodiments, the number of the plurality of samples is equal to the number of the plurality of columns or rows.

In some embodiments, a template size for LIC is larger than at least one of: a row of samples, or a column or samples.

In some embodiments, the prediction by the LIC is determined based on a plurality of rows or columns of neighboring samples.

In some embodiments, the plurality of rows or columns of neighboring samples is adjacent to at least one of: the current video block, or a reference block of the current video block.

According to further embodiments of the present disclosure, a non-transitory computer-readable recording medium is provided. The non-transitory computer-readable recording medium stores a bitstream of a video which is generated by a method performed by an apparatus for video processing. In the method, a prediction of a current video block of the video is determined based on a local illumination compensation (LIC). The LIC is based on a regression model modulating a relationship between a current area and a reference area of the current video block for the LIC. The bitstream is generated based on the prediction.

According to still further embodiments of the present disclosure, a method for storing bitstream of a video is provided. In the method, a prediction of a current video block of the video is determined based on a local illumination compensation (LIC). The LIC is based on a regression model modulating a relationship between a current area and a reference area of the current video block for the LIC. The bitstream is generated based on the prediction. The bitstream is stored in a non-transitory computer-readable recording medium.

FIG. 28 illustrates a flowchart of a method 2800 for video processing in accordance with embodiments of the present disclosure. The method 2800 is implemented for a conversion between a current video block of a video and a bitstream of the video.

At block 2810, at least one intra fusion for at least one color component is applied to the current video block based on more than two reference lines.

At block 2820, the conversion is performed based on the applying. In some embodiments, the conversion includes encoding the current video block into the bitstream. Alternatively, or in addition, in some embodiments, the conversion includes decoding the current video block from the bitstream.

The method 2800 enables intra fusion for the color component such as luma component or chroma component. In this way, the coding efficiency and/or coding effectiveness can be improved.

In some embodiments, the at least one intra fusion for at least one color component comprises at least one of: an intra luma fusion, or an intra chroma fusion. For example, intra luma fusion and/or intra chroma fusion may be applied based on more than two reference lines.

In some embodiments, the at least one intra fusion is applied based on a regression model. By way of example, the regression model may include at least one of: a linear regression model, a non-linear regression model, or a polynomial regression model. For example, intra luma fusion and/or intra chroma fusion may be applied based on a linear/non-linear/polynomial regression model.

In some embodiments, applying the at least one intra fusion to the current video block comprises: determining a plurality of predictions of the at least one color component based on a plurality of reference lines of the current video block; and determining a fusion of the plurality of predictions based on a plurality of weights.

In some embodiments, the plurality of weights is determined based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool. For example, the weights of different predictions from different reference lines may be calculated based on LDL decomposition, or gaussian elimination, or least square, of LU decomposition, or Cholesky decomposition, etc.

According to further embodiments of the present disclosure, a non-transitory computer-readable recording medium is provided. The non-transitory computer-readable recording medium stores a bitstream of a video which is generated by a method performed by an apparatus for video processing. In the method, at least one intra fusion for at least one color component is applied to a current video block of the video based on more than two reference lines. The bitstream is generated based on the applying.

According to still further embodiments of the present disclosure, a method for storing bitstream of a video is provided. In the method, at least one intra fusion for at least one color component is applied to a current video block of the video based on more than two reference lines. The bitstream is generated based on the applying. The bitstream is stored in a non-transitory computer-readable recording medium.

In some embodiments, information regarding whether to and/or how to apply the method 2600, method 2700 and/or method 2800 is included in the bitstream.

In some embodiments, the information is indicated at one of: a sequence level, a group of pictures level, a picture level, a slice level, or a tile group level.

In some embodiments, the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header, or a tile group header.

In some embodiments, the information is indicated in a region containing more than one sample or pixel.

In some embodiments, the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

In some embodiments, the method 2800 further comprises: determining the information based on coded information.

In some embodiments, the coded information comprises at least one of: a block size, a color format, a single or dual tree partitioning, a color component, a slice type, or a picture type.

It is to be understood that the methods 2600, 2700 and 2800 may be applied separately or in any combination. By using these methods 2600, 2700 and/or 2800 separately or in combination, the coding effectiveness and/or coding efficiency can be improved.

Implementations of the present disclosure can be described in view of the following clauses, the features of which can be combined in any reasonable manner.

Clause 1. A method for video processing, comprising: determining, for a conversion between a current video block of a video and a bitstream of the video, a filtered prediction of the current video block based on an offset based regression model, the offset based regression model modulating a relationship between a current area and a reference area of the current video block; and performing the conversion based on the filtered prediction.

Clause 2. The method of clause 1, wherein the offset based regression model comprises at least one of: an offset based linear regression model, an offset based non-linear regression model, or an offset based polynomial regression model.

Clause 3. The method of clause 1 or 2, wherein the current video block comprises an intra template matching prediction (intraTMP) block, and the filtered prediction is a final prediction of the current video block.

Clause 4. The method of any of clauses 1-3, wherein determining the filtered prediction comprises: determining a plurality of samples in the reference area; determining a plurality of values based on the plurality of samples and an offset; determining a final sample in the current area based on a weighted sum of the plurality of values and a bias value; and determining the filter prediction based on the final sample.

Clause 5. The method of clause 4, wherein the plurality of values is determined by subtracting the offset from the plurality of samples.

Clause 6. The method of clause 4 or 5, wherein the weighted sum is determined based on a plurality of filter coefficients for the plurality of values and the bias value.

Clause 7. The method of clause 6, wherein the plurality of filter coefficients is determined based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool.

Clause 8. The method of any of clauses 4-8, wherein the offset is determined based on at least one reference sample located at at least one predefined position.

Clause 9. The method of any of clauses 4-8, wherein the offset is determined based on a metric value of samples within the reference area.

Clause 10. The method of clause 9, wherein the metric value comprises one of: an average value, a mean value, a middle value, a maximum value or a minimum value.

Clause 11. The method of any of clauses 4-10, wherein the offset is zero.

Clause 12. The method of any of clauses 4-11, wherein the bias value is determined based on a bit depth of a video sequence of the video.

Clause 13. The method of clause 12, wherein the bit depth is 10-bit, and the bias value is 512.

Clause 14. The method of clause 12, wherein the bit depth is 8-bit, and the bias value is 256.

Clause 15. The method of clause 12, wherein the bias value is determined by: 1<<(bitDepth−1), where bitDepth denotes an internal bit depth of s sample of at least one of: a luma array or a chroma array, <<denotes an arithmetic left shift operation.

Clause 16. The method of any of clauses 4-11, wherein the bias value is zero.

Clause 17. The method of any of clauses 4-16, wherein the plurality of samples is neighboring to each other.

Clause 18. The method of clause 17, wherein the plurality of samples comprises a first sample at a center of the reference area, a second sample above to the first sample, a third sample bottom to the first sample, a fourth sample left to the first sample, and a fifth sample right to the first sample.

Clause 19. The method of any of clauses 4-16, wherein the plurality of samples is in a plurality of prediction candidates of the current video block.

Clause 20. The method of clause 19, wherein the number of the plurality of samples is equal to the number of the plurality of prediction candidates.

Clause 21. The method of any of clauses 4-16, wherein the plurality of samples is in a plurality of reference lines of the current video block.

Clause 22. The method of clause 21, wherein the number of the plurality of samples is equal to the number of the plurality of reference lines.

Clause 23. The method of any of clauses 4-16, wherein the plurality of samples is in a plurality of columns or rows within a template of the current video block.

Clause 24. The method of clause 23, wherein the number of the plurality of samples is equal to the number of the plurality of columns or rows.

Clause 25. The method of any of clauses 1-24, wherein a list of filtered prediction candidates of the current video block is determined, an indication in the bitstream indicating the filtered prediction in the list of filtered prediction candidates.

Clause 26. The method of clause 25, wherein the list of filtered prediction candidates is reordered based on template cost.

Clause 27. The method of clause 25 or 26, wherein a first number of filtered prediction candidates are selected from the list of filtered prediction candidates, and the filtered prediction is selected from the first number of filtered prediction candidates, the first number being less than a total number of candidates in the list of filtered prediction candidates.

Clause 28. The method of clause 27, wherein the first number of filtered prediction candidates are selected based on template costs of the list of filtered prediction candidates.

Clause 29. The method of any of clauses 25-28, wherein the indication comprises a syntax parameter included at a block level in the bitstream.

Clause 30. The method of clause 29, wherein the syntax parameter comprises an index of a candidate.

Clause 31. The method of any of clauses 1-24, wherein a list of filtered prediction candidates of the current video block is determined, and the filtered prediction is determined based on template costs of the filtered prediction candidates in the list.

Clause 32. The method of clause 31, wherein a template cost of a filtered prediction candidate comprises one of: a sum of absolute differences (SAD), a sum of absolute transformed differences (SATD), a mean removal SAD, or an offset removal SAD.

Clause 33. The method of any of clauses 1-32, wherein determining the filtered prediction comprises: determining a plurality of filtered prediction candidates; and determining the filtered prediction of the current video block based on a fusion of the plurality of filtered prediction candidates.

Clause 34. The method of clause 33, wherein the fusion is determined based on blending weights of the plurality of filtered prediction candidates, the blending weights being determined based on a sum of absolute differences (SAD) cost or a sum of absolute transformed differences (SATD) cost.

Clause 35. The method of clause 33, wherein the fusion is determined based on blending weights of the plurality of filtered prediction candidates, the blending weights being predefined fixed values.

Clause 36. The method of clause 33, wherein the fusion is determined based on blending weights of the plurality of filtered prediction candidates, the blending weights being determined based on at least one of: an LDL decomposition, an LU decomposition, or a Gaussian elimination.

Clause 37. The method of any of clauses 33-36, wherein whether to apply a fusion or a filtering for a final prediction of the current video block is included in the bitstream.

Clause 38. A method for video processing, comprising: determining, for a conversion between a current video block of a video and a bitstream of the video, a prediction of the current video block based on a local illumination compensation (LIC), the LIC being based on a regression model modulating a relationship between a current area and a reference area of the current video block for the LIC; and performing the conversion based on the prediction.

Clause 39. The method of clause 38, wherein the regression model comprises at least one of: a linear regression model, a non-linear regression model, or a polynomial regression model.

Clause 40. The method of clause 38 or 39, wherein determining the prediction comprises: determining a plurality of samples in the reference area; determining a plurality of values based on the plurality of samples and an offset; determining a final sample in the current area based on a weighted sum of the plurality of values and a bias value; and determining the prediction based on the final sample.

Clause 41. The method of clause 40, wherein the plurality of values is determined by subtracting the offset from the plurality of samples.

Clause 42. The method of clause 40 or 41, wherein the weighted sum is determined based on a plurality of filter coefficients for the plurality of values and the bias value.

Clause 43. The method of clause 42, wherein the plurality of filter coefficients is determined based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool.

Clause 44. The method of any of clauses 40-43, wherein the offset is determined based on at least one reference sample located at at least one predefined position.

Clause 45. The method of any of clauses 40-43, wherein the offset is determined based on a metric value of samples within the reference area.

Clause 46. The method of clause 45, wherein the metric value comprises one of: an average value, a mean value, a middle value, a maximum value or a minimum value.

Clause 47. The method of any of clauses 40-46, wherein the offset is zero.

Clause 48. The method of any of clauses 40-47, wherein the bias value is determined based on a bit depth of a video sequence of the video.

Clause 49. The method of clause 48, wherein the bit depth is 10-bit, and the bias value is 512.

Clause 50. The method of clause 48, wherein the bit depth is 8-bit, and the bias value is 256.

Clause 51. The method of any of clauses 40-47, wherein the bias value is zero.

Clause 52. The method of any of clauses 40-51, wherein the plurality of samples is neighboring to each other.

Clause 53. The method of clause 52, wherein the plurality of samples comprises a first sample at a center of the reference area, a second sample above to the first sample, a third sample bottom to the first sample, a fourth sample left to the first sample, and a fifth sample right to the first sample.

Clause 54. The method of any of clauses 40-51, wherein the plurality of samples is in a plurality of reference lines of the current video block.

Clause 55. The method of clause 54, wherein the number of the plurality of samples is equal to the number of the plurality of reference lines.

Clause 56. The method of any of clauses 40-51, wherein the plurality of samples is in a plurality of columns or rows within a template of the current video block.

Clause 57. The method of clause 56, wherein the number of the plurality of samples is equal to the number of the plurality of columns or rows.

Clause 58. The method of any of clauses 38-57, wherein a template size for LIC is larger than at least one of: a row of samples, or a column or samples.

Clause 59. The method of any of clauses 38-58, wherein the prediction by the LIC is determined based on a plurality of rows or columns of neighboring samples.

Clause 60. The method of clause 59, wherein the plurality of rows or columns of neighboring samples is adjacent to at least one of: the current video block, or a reference block of the current video block.

Clause 61. A method for video processing, comprising: applying, for a conversion between a current video block of a video and a bitstream of the video, at least one intra fusion for at least one color component to the current video block based on more than two reference lines; and performing the conversion based on the applying.

Clause 62. The method of clause 61, wherein the at least one intra fusion for at least one color component comprises at least one of: an intra luma fusion, or an intra chroma fusion.

Clause 63. The method of clause 61 or 62, wherein the at least one intra fusion is applied based on a regression model.

Clause 64. The method of clause 63, wherein the regression model comprises at least one of: a linear regression model, a non-linear regression model, or a polynomial regression model.

Clause 65. The method of any of clauses 61-64, wherein applying the at least one intra fusion to the current video block comprises: determining a plurality of predictions of the at least one color component based on a plurality of reference lines of the current video block; and determining a fusion of the plurality of predictions based on a plurality of weights.

Clause 66. The method of clause 65, wherein the plurality of weights is determined based on at least one of: an LDL decomposition or a variant of LDL decomposition, an LU decomposition or a variant of LU decomposition, a Cholesky decomposition or a variant of Cholesky decomposition, a Gaussian elimination or a variant of Gaussian elimination, or a least square tool or a variant of least square tool.

Clause 67. The method of any of clauses 1-66, wherein information regarding whether to and/or how to apply the method is included in the bitstream.

Clause 68. The method of clause 67, wherein the information is indicated at one of: a sequence level, a group of pictures level, a picture level, a slice level, or a tile group level.

Clause 69. The method of clause 67 or 68, wherein the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header, or a tile group header.

Clause 70. The method of any of clauses 67-69, wherein the information is indicated in a region containing more than one sample or pixel.

Clause 71. The method of clause 70, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

Clause 72. The method of any of clauses 67-71, further comprising: determining the information based on coded information.

Clause 73. The method of clause 72, wherein the coded information comprises at least one of: a block size, a color format, a single or dual tree partitioning, a color component, a slice type, or a picture type.

Clause 74. The method of any of clauses 1-73, wherein the conversion comprises encoding the current video block into the bitstream.

Clause 75. The method of any of clauses 1-73, wherein the conversion comprises decoding the current video block from the bitstream.

Clause 76. An apparatus for video processing comprising a processor and a non-transitory memory with instructions thereon, wherein the instructions upon execution by the processor, cause the processor to perform a method in accordance with any of clauses 1-75.

Clause 77. A non-transitory computer-readable storage medium storing instructions that cause a processor to perform a method in accordance with any of clauses 1-75.

Clause 78. A non-transitory computer-readable recording medium storing a bitstream of a video which is generated by a method performed by an apparatus for video processing, wherein the method comprises: determining a filtered prediction of a current video block of the video based on an offset based regression model, the offset based regression model modulating a relationship between a current area and a reference area of the current video block; and generating the bitstream based on the filtered prediction.

Clause 79. A method for storing a bitstream of a video, comprising: determining a filtered prediction of a current video block of the video based on an offset based regression model, the offset based regression model modulating a relationship between a current area and a reference area of the current video block; generating the bitstream based on the filtered prediction; and storing the bitstream in a non-transitory computer-readable recording medium.

Clause 80. A non-transitory computer-readable recording medium storing a bitstream of a video which is generated by a method performed by an apparatus for video processing, wherein the method comprises: determining a prediction of a current video block of the video based on a local illumination compensation (LIC), the LIC being based on a regression model modulating a relationship between a current area and a reference area of the current video block for the LIC; and generating the bitstream based on the prediction.

Clause 81. A method for storing a bitstream of a video, comprising: determining a prediction of a current video block of the video based on a local illumination compensation (LIC), the LIC being based on a regression model modulating a relationship between a current area and a reference area of the current video block for the LIC; generating the bitstream based on the prediction; and storing the bitstream in a non-transitory computer-readable recording medium.

Clause 82. A non-transitory computer-readable recording medium storing a bitstream of a video which is generated by a method performed by an apparatus for video processing, wherein the method comprises: applying at least one intra fusion for at least one color component to a current video block of the video based on more than two reference lines; and generating the bitstream based on the applying.

Clause 83. A method for storing a bitstream of a video, comprising: applying at least one intra fusion for at least one color component to a current video block of the video based on more than two reference lines; generating the bitstream based on the applying; and storing the bitstream in a non-transitory computer-readable recording medium.

### Example Device

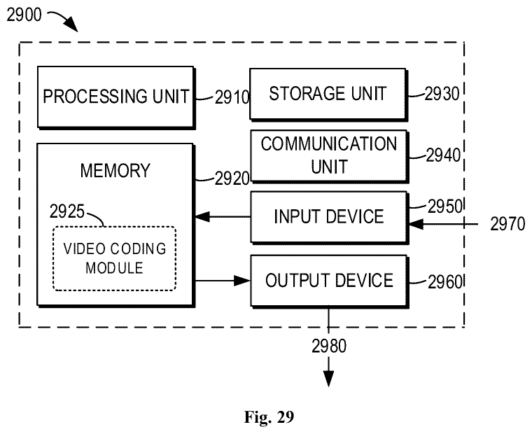

FIG. 29 illustrates a block diagram of a computing device 2900 in which various embodiments of the present disclosure can be implemented. The computing device 2900 may be implemented as or included in the source device 110 (or the video encoder 114 or 200) or the destination device 120 (or the video decoder 124 or 300).

It would be appreciated that the computing device 2900 shown in FIG. 29 is merely for purpose of illustration, without suggesting any limitation to the functions and scopes of the embodiments of the present disclosure in any manner.

As shown in FIG. 29, the computing device 2900 includes a general-purpose computing device 2900. The computing device 2900 may at least comprise one or more processors or processing units 2910, a memory 2920, a storage unit 2930, one or more communication units 2940, one or more input devices 2950, and one or more output devices 2960.

In some embodiments, the computing device 2900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2900 can support any type of interface to a user (such as “wearable” circuitry and the like).

The processing unit 2910 may be a physical or virtual processor and can implement various processes based on programs stored in the memory 2920. In a multi-processor system, multiple processing units execute computer executable instructions in parallel so as to improve the parallel processing capability of the computing device 2900. The processing unit 2910 may also be referred to as a central processing unit (CPU), a microprocessor, a controller or a microcontroller.

The computing device 2900 typically includes various computer storage medium. Such medium can be any medium accessible by the computing device 2900, including, but not limited to, volatile and non-volatile medium, or detachable and non-detachable medium. The memory 2920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2930 may be any detachable or non-detachable medium and may include a machine-readable medium such as a memory, flash memory drive, magnetic disk or another other media, which can be used for storing information and/or data and can be accessed in the computing device 2900.

The computing device 2900 may further include additional detachable/non-detachable, volatile/non-volatile memory medium. Although not shown in FIG. 29, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2940 communicates with a further computing device via the communication medium. In addition, the functions of the components in the computing device 2900 can be implemented by a single computing cluster or multiple computing machines that can communicate via communication connections. Therefore, the computing device 2900 can operate in a networked environment using a logical connection with one or more other servers, networked personal computers (PCs) or further general network nodes.

The input device 2950 may be one or more of a variety of input devices, such as a mouse, keyboard, tracking ball, voice-input device, and the like. The output device 2960 may be one or more of a variety of output devices, such as a display, loudspeaker, printer, and the like. By means of the communication unit 2940, the computing device 2900 can further communicate with one or more external devices (not shown) such as the storage devices and display device, with one or more devices enabling the user to interact with the computing device 2900, or any devices (such as a network card, a modem and the like) enabling the computing device 2900 to communicate with one or more other computing devices, if required. Such communication can be performed via input/output (I/O) interfaces (not shown).

In some embodiments, instead of being integrated in a single device, some or all components of the computing device 2900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2900 may be used to implement video encoding/decoding in embodiments of the present disclosure. The memory 2920 may include one or more video coding modules 2925 having one or more program instructions. These modules are accessible and executable by the processing unit 2910 to perform the functionalities of the various embodiments described herein.

In the example embodiments of performing video encoding, the input device 2950 may receive video data as an input 2970 to be encoded. The video data may be processed, for example, by the video coding module 2925, to generate an encoded bitstream. The encoded bitstream may be provided via the output device 2960 as an output 2980.

In the example embodiments of performing video decoding, the input device 2950 may receive an encoded bitstream as the input 2970. The encoded bitstream may be processed, for example, by the video coding module 2925, to generate decoded video data. The decoded video data may be provided via the output device 2960 as the output 2980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method for video processing, comprising:
determining, for a conversion between a current video block of a video and a bitstream of the video, a filtered prediction of the current video block based on an offset based regression model, the offset based regression model modulating a relationship between a current area and a reference area of the current video block; and
performing the conversion based on the filtered prediction.

2. The method of claim 1, wherein the offset based regression model comprises at least one of: an offset based linear regression model, an offset based non-linear regression model, or an offset based polynomial regression model, and/or
wherein the current video block comprises an intra template matching prediction (intraTMP) block, and the filtered prediction is a final prediction of the current video block.

3. The method of claim 1, wherein determining the filtered prediction comprises:
determining a plurality of samples in the reference area;
determining a plurality of values based on the plurality of samples and an offset;
determining a final sample in the current area based on a weighted sum of the plurality of values and a bias value; and
determining the filter prediction based on the final sample.

4. The method of claim 3, wherein the plurality of values is determined by subtracting the offset from the plurality of samples,
wherein the weighted sum is determined based on a plurality of filter coefficients for the plurality of values and the bias value,
wherein the plurality of filter coefficients is determined based on at least one of:
an LDL decomposition or a variant of LDL decomposition,
an LU decomposition or a variant of LU decomposition,
a Cholesky decomposition or a variant of Cholesky decomposition,
a Gaussian elimination or a variant of Gaussian elimination, or
a least square tool or a variant of least square tool.

5. The method of claim 3, wherein the offset is determined based on at least one reference sample located at at least one predefined position, or
wherein the offset is determined based on a metric value of samples within the reference area, wherein the metric value comprises one of: an average value, a mean value, a middle value, a maximum value or a minimum value, or
wherein the offset is zero.

6. The method of claim 3, wherein the bias value is determined based on a bit depth of a video sequence of the video,
wherein the bit depth is 10-bit, and the bias value is 512, or
wherein the bit depth is 8-bit, and the bias value is 256, or
wherein the bias value is determined by: 1<<(bitDepth−1), where bitDepth denotes an internal bit depth of s sample of at least one of: a luma array or a chroma array, <<denotes an arithmetic left shift operation, or wherein the bias value is zero.

7. The method of claim 3, wherein the plurality of samples is neighboring to each other, wherein the plurality of samples comprises a first sample at a center of the reference area, a second sample above to the first sample, a third sample bottom to the first sample, a fourth sample left to the first sample, and a fifth sample right to the first sample.

8. The method of claim 3, wherein the plurality of samples is in a plurality of prediction candidates of the current video block, wherein the number of the plurality of samples is equal to the number of the plurality of prediction candidates.

9. The method of claim 3, wherein the plurality of samples is in a plurality of reference lines of the current video block, wherein the number of the plurality of samples is equal to the number of the plurality of reference lines, or
wherein the plurality of samples is in a plurality of columns or rows within a template of the current video block, wherein the number of the plurality of samples is equal to the number of the plurality of columns or rows.

10. The method of claim 1, wherein a list of filtered prediction candidates of the current video block is determined, an indication in the bitstream indicating the filtered prediction in the list of filtered prediction candidates.

11. The method of claim 10, wherein the list of filtered prediction candidates is reordered based on template cost,
wherein a first number of filtered prediction candidates are selected from the list of filtered prediction candidates, and the filtered prediction is selected from the first number of filtered prediction candidates, the first number being less than a total number of candidates in the list of filtered prediction candidates, wherein the first number of filtered prediction candidates are selected based on template costs of the list of filtered prediction candidates.

12. The method of claim 10, wherein the indication comprises a syntax parameter included at a block level in the bitstream,
wherein the syntax parameter comprises an index of a candidate.

13. The method of claim 1, wherein a list of filtered prediction candidates of the current video block is determined, and the filtered prediction is determined based on template costs of the filtered prediction candidates in the list,
wherein a template cost of a filtered prediction candidate comprises one of:
a sum of absolute differences (SAD),
a sum of absolute transformed differences (SATD),
a mean removal SAD, or
an offset removal SAD.

14. The method of claim 1, wherein determining the filtered prediction comprises:
determining a plurality of filtered prediction candidates; and
determining the filtered prediction of the current video block based on a fusion of the plurality of filtered prediction candidates.

15. The method of claim 14, wherein the fusion is determined based on blending weights of the plurality of filtered prediction candidates, the blending weights being determined based on a sum of absolute differences (SAD) cost or a sum of absolute transformed differences (SATD) cost, or
wherein the fusion is determined based on blending weights of the plurality of filtered prediction candidates, the blending weights being predefined fixed values, or
wherein the fusion is determined based on blending weights of the plurality of filtered prediction candidates, the blending weights being determined based on at least one of:
an LDL decomposition,
an LU decomposition, or
a Gaussian elimination.

16. The method of claim 14, wherein whether to apply a fusion or a filtering for a final prediction of the current video block is included in the bitstream.

17. The method of claim 1, wherein the conversion comprises encoding the current video block into the bitstream, or
wherein the conversion comprises decoding the current video block from the bitstream.

18. An apparatus for processing video data comprising a processor and a non-transitory memory with instructions thereon, wherein the instructions upon execution by the processor, cause the processor to:
determine, for a conversion between a current video block of a video and a bitstream of the video, a filtered prediction of the current video block based on an offset based regression model, the offset based regression model modulating a relationship between a current area and a reference area of the current video block; and
perform the conversion based on the filtered prediction.

19. A non-transitory computer-readable storage medium storing instructions that cause a processor to perform a method comprising:
determining, for a conversion between a current video block of a video and a bitstream of the video, a filtered prediction of the current video block based on an offset based regression model, the offset based regression model modulating a relationship between a current area and a reference area of the current video block; and
performing the conversion based on the filtered prediction.

20. A non-transitory computer-readable recording medium storing a bitstream of a video which is generated by a method performed by a video processing apparatus, wherein the method comprises:
determining a filtered prediction of a current video block of the video based on an offset based regression model, the offset based regression model modulating a relationship between a current area and a reference area of the current video block; and
generating the bitstream based on the filtered prediction.
